(19) United States
(12) Patent Application Publication
(10) Pub. No.: US 2008/0133692 A1
(43) Pub. Date: Jun. 5, 2008

(54) Multiple computer system with redundancy architecture

(76) Inventor: John M. Holt, Essex (GB)

Correspondence Address: PERKINS COIE LLP, P.O. BOX 2168, MENLO PARK, CA, 94026, US

(21) Appl. No.: 11/973,399

(22) Filed: Oct. 5, 2007

Related U.S. Application Data
(60) Provisional application No. 60/850,508, filed on Oct. 9, 2006.

(30) Foreign Application Priority Data
Oct. 5, 2006 (AU) 2006905526

(51) Int. Cl. G06F 15/167

(52) U.S. Cl. 709/212

(57) ABSTRACT

An architecture for multiple computer systems which incorporates redundancy is disclosed. For each group of “n” first computers M1/1, M2/1, . . . Mn/1, a second “mirror” group of computers M1/2, M2/2 . . . Mn/2 is provided. Changes to the memory locations of each computer of the first group are communicated to the corresponding computers of the second group to update a replicated memory. Both distributed shared memory (DSM) and replicated shared memory (RSM) are disclosed.

The present application claims the benefit of priority to U.S. Provisional Application Nos. 60/850,508 (5027V-US) filed 9 Oct. 2006; and to Australian Provisional Application Nos. 2006905526 (5027V-AU) filed on 5 Oct. 2006, each of which are hereby incorporated herein by reference.

This application is related to concurrently filed U.S. Application entitled “Multiple Computer System with Redundancy Architecture,” (Attorney Docket No. 61130-8021.US01 (5027V-US01)) and concurrently filed U.S. Application entitled “Multiple Computer System with Redundancy Architecture,” (Attorney Docket No. 61130-8021.US02 (5027V-US02)), each of which are hereby incorporated herein by reference.

### FIELD OF THE INVENTION

The present invention relates to multiple computer systems and to single computer systems operating in a multiple computer system environment. In particular, the present invention relates to the provision of redundancy in multiple computer systems.

### BACKGROUND OF THE INVENTION

Ideally, redundancy is provided in a multiple computer system so that in the event that one computer fails, not only is the data which is stored in local application memory of the failed computer preserved on another computer, but that other computer (or a different computer), or a number of computers is/are able to step in and undertake the computing task previously undertaken by the application program of the failed computer.

Hitherto, such redundancy has not been available. For example, in super computing a “checkpoint” system is used. Under this arrangement at predetermined intervals of, say, every hour or after some predetermined or dynamically determined number of operations have been performed, executing stops and a permanent record is made of the current status and current data of each computer. As a consequence, in the event of a failure, it is necessary to stop all computers, restore the status and data as of the last checkpoint, and then with a replaced computer, or a repaired computer, recommence executing instructions as of the last checkpoint.

Another form of multiple computer system is that known as Distributed Shared Memory (DSM). Here individual computers are interconnected by means of a communications network or some other equivalent communications link and the local memory of each of the computers is accessible by any one of the other computers. Hitherto in DSM computing redundancy has not been possible.

A different form of multiple computer system has recently been described, but not commercially used, and this is known as Replicated Shared Memory (RSM). This system is described in International Patent Application No. PCT/AU2005/000580 (Attorney Ref 5027F-WO) published under WO 2005/103926 (to which U.S. patent application Ser. No. 11/111,946 and published under No. 2005-0262313 corresponds) in the name of the present applicant. This specification discloses how different portions of an application program written to execute on only a single computer can be operated substantially simultaneously on a corresponding different one of a plurality of computers. That simultaneous operation has not been commercially used as of the priority date of the present application. International Patent Application Nos. PCT/AU2005/001641 (WO 2006/110,937) (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds and PCT/AU2006/000532 (WO 2006/110,957) (Attorney Ref: 5027F-D2-WO) both in the name of the present applicant and both unpublished as at the priority date of the present application, also disclose further details. The contents of the specification of each of the abovementioned prior application(s) are hereby incorporated into the present specification by cross reference for all purposes.

Briefly stated, the abovementioned patent specifications disclose that at least one application program written to be operated on only a single computer can be simultaneously operated on a number of computers each with independent local memory. The memory locations required for the operation of that program are replicated in the independent local memory of each computer. On each occasion on which the application program writes new data to any replicated memory location, that new data is transmitted and stored at each corresponding memory location of each computer. Thus apart from the possibility of transmission delays, each computer has a local memory the contents of which are substantially identical to the local memory of each other computer and are updated to remain so. Since all application programs, in general, read data much more frequently than they cause new data to be written, the abovementioned arrangement enables very substantial advantages in computing speed to be achieved. In particular, the stratagem enables two or more commodity computers interconnected by a commodity communications network to be operated simultaneously running under the application program written to be executed on only a single computer.

### GENESIS OF THE INVENTION

The genesis of the present invention is a desire to provide at least some redundancy in multiple computer systems.

### SUMMARY OF THE INVENTION

According to a first aspect of the present invention there is disclosed a multiple computer system having a first plurality of computers each interconnected via a communications network and a second like plurality of computers interconnected therewith, at least one memory location in each said second computer being a replica of a corresponding memory location in the corresponding first computer, and said system including updating means whereby changes to the contents or values of said memory locations in said first computers are transmitted to the corresponding memory locations of said second computers.

According to a second aspect of the present invention there is disclosed a dual computer system comprising a first computer having an application program which is intolerant of computer failure, a second computer connected thereto to mirror said first computer, said second computer having a replica of said application program and having memory locations which replicate those of said first computer, and said computer system having updating means to update said second computer memory locations with changes to the contents or values of the corresponding memory locations of said first computer.

According to a third aspect of the present invention there is disclosed a single computer adapted to operate in a multiple computer system or a dual computer system as claimed above, said single computer comprising:

an independent local memory able to be updated via a communications port which is able to be connected to the communications network of said multiple computer system, and updating means connected to said communication port whereby changes to the contents or values of said memory locations of said single computer are able to be transmitted to the communications port of a like computer comprising a corresponding second computer of the multiple computer system.

According to a fourth aspect of the present invention there is disclosed a method of operating multiple computers to form a multiple computer system, said method comprising the steps of:
(i) interconnecting a first plurality of computers via a communications network,
(ii) interconnecting a like plurality of second computers to said first plurality of computers,
(iii) forming in each second computer a replica of at least one memory location of the corresponding first computer, and
   updating said second computers whereby changes to the contents or values of the memory locations in said first computers are transmitted to the corresponding memory locations of said second computers.

According to a fifth aspect of the present invention there is disclosed a method of operating a dual computer system, said method comprising the steps of:

(i) providing a first computer,
(ii) loading into said first computer an application program which is intolerant of failure of said first computer,
(iii) connecting a second computer to said first computer,
(iv) loading a replica of said application program in said second computer,
(v) replicating memory locations of said first computer in said second computer, and
(vi) updating changes in the content or value of said memory locations of said first computer to the corresponding memory locations of said second computer.

According to a sixth aspect of the present invention there is disclosed a multiple computer system comprising a first plurality of computers each of which is connected to each other by means of a communications network, a second like plurality of computers each of which is connected to each other by means of said communications network, and a substantially direct communications link between each of said first computers and the corresponding second computer.

### BRIEF DESCRIPTION OF THE DRAWINGS

Embodiments of the present invention will now be described with reference to the drawings in which:

FIG. 1 is a schematic representation of a Redundant Array of Independent Disks (RAID) in which static data is able to be stored in a redundant matter,

FIG. 2 is a schematic representation of a DSM multiple computer system,

FIG. 3A is a schematic illustration of a prior art computer arranged to operate JAVA code and thereby constitute a single JAVA virtual machine,

FIG. 3B is a drawing similar to FIG. 3A but illustrating the initial loading of code,

FIG. 3C illustrates the interconnection of a multiplicity of computers each being a JAVA virtual machine to form a multiple computer system,

FIG. 4 schematically illustrates “n” application running computers to which at least one additional server machine X is connected,

FIG. 4A is a schematic representation of an RSM multiple computer system,

FIG. 4B is a similar schematic representation of a partial or hybrid RSM multiple computer system

FIG. 5 is a schematic representation of an RSM multiple computer system having a first group of “n” machines and a second group of “n” machines to provide redundancy,

FIG. 6 is a modification to the arrangement illustrated in FIG. 5 in which each machine in the first group is able to directly communicate with the corresponding machine of the second group,

FIG. 6A is a modification to the arrangement illustrated in FIG. 6 in which operation for partially replicated application memory locations/contents/values is shown,

FIG. 7 is a view similar to FIG. 6 and illustrating partial replicated shared memory,

FIG. 8 is a schematic representation of a DSM multiple computer system having a first group of “n” computers and a second group of “n” computers to provide redundancy,

FIG. 9 illustrates a single computer together with a single mirror machine to provide redundancy, and

FIG. 10 shows a cluster of four computers each of which is provided with its own mirror machine.

### DETAILED DESCRIPTION

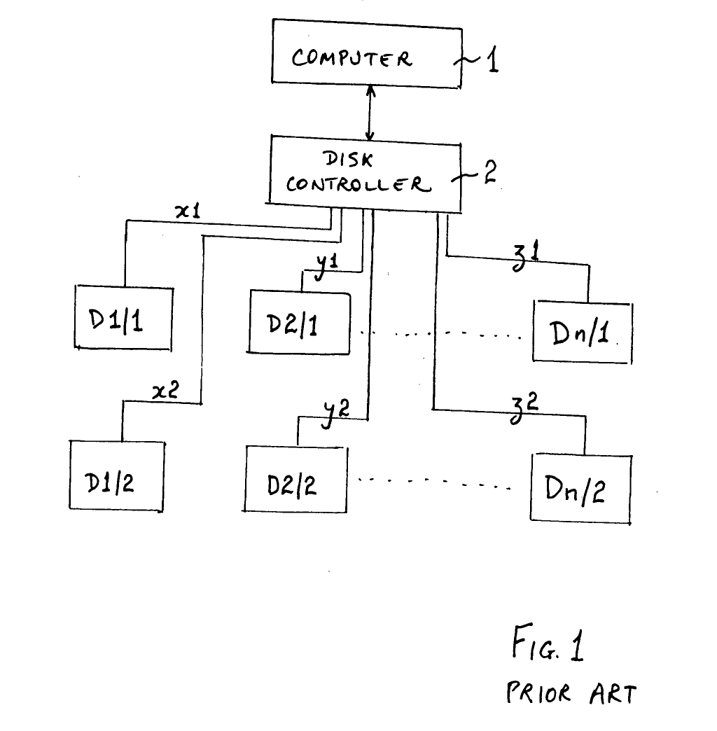

In computing tasks where continued access to stored data on a disk drive storage device is crucial, it is known to provide disk drive redundancy by means of a Redundant Array of Independent Disks (RAID) and such an arrangement is schematically illustrated in FIG. 1. It is important to note in this connection that the redundancy of the disk drive is in relation to failure of a single disk and has nothing to do with the failure of the computer which needs to access the data stored on the disk. It is also noted that the data is static in the sense that the data once written to the disk does not change and is persistent until it is eventually overwritten.

In the arrangement illustrated in FIG. 1, a computer 1 is connected to a disk controller 2 which is in turn connected to a first group of “n” disks D1/1, D2/1 . . . Dn/1, “n” being an integer greater than or equal to 2. In addition, the disk controller 2 is also connected to a second group of “n” disks D1/2, D2/2 . . . Dn/2. The second group of disks is said to “mirror” the first group of disks. Conventional mirroring as a way to provide a redundant copy of a disk drive is known in the art and is not described in greater detail here in.

Data from the computer 1 is sent to the disk controller where a decision is made as to what data to store on which disk. Some data x is stored both on disk D1/1 and also on D1/2. Such data is indicated as x1 being stored on disk D1/1 and as x2 being stored on disk D1/2, however, it is understood that the data itself is identical. Similarly, other data “y” is stored both on disk D2/1 and on D2/2. Finally, further data “z” is stored both on disk Dn/1 and on Dn/2.

In the event that all disks are working properly, the disk controller if asked to read data reads the data from the first group of disks and thus in a particular instance, the data read may be represented as (x1+y1+z1). However, in the event that disk D2/1 (for example) should fail, then the disk controller instead of reading the data from the failed disk reads the data from its mirror equivalent and thus the data read is (x1+y2+z1) which is identical to that which would have been read had disk D2/1 not failed. In the above manner, failure of any one or more of the disks in the first group can be accommodated, provided that a disk in the first group and its corresponding disk in the second group do not fail simultaneously. Since this is a highly unlikely event from the statistical point of view, in practice more than adequate redundancy is provided. However, it should be noted that the computer 1 is not a multiple computer system and that the redundancy is only in respect of the static data stored on the disks and so the RAID system does not provide any assistance in the event of the failure of computer 1, or of the disk controller controlling the failed disk drive.

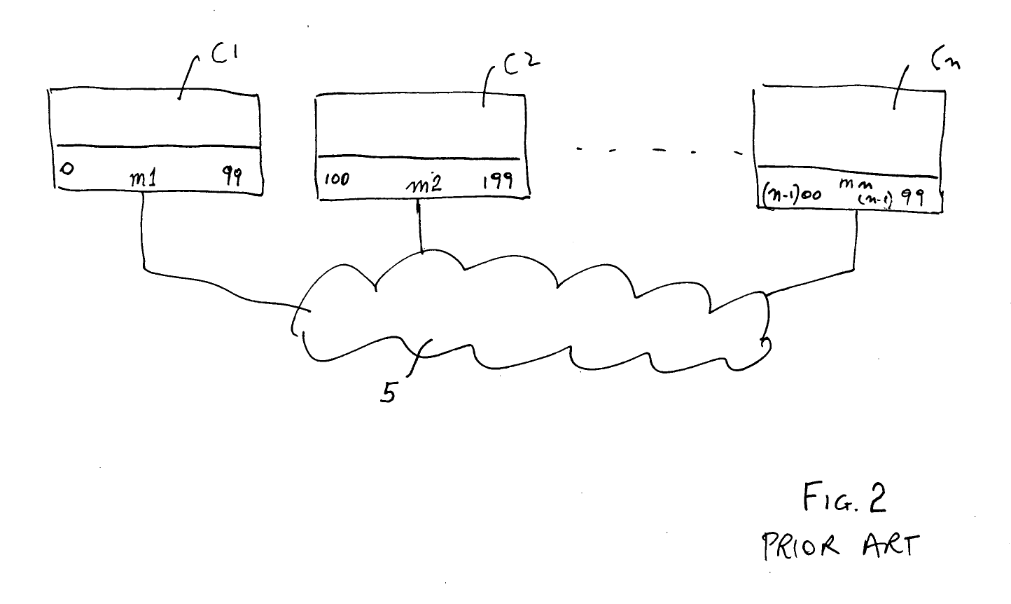

Turning now to FIG. 2, a known multiple computer system is illustrated in which “n” computers C1, C2 . . . Cn are provided each of which has a corresponding local memory m1, m2 . . . mn. The computers C1, C2 . . . Cn are interconnected by means of a communication system 5 which typically takes the form of a commercially available ETHERNET or similar. For the purposes of explanation, each of the individual memories is provided with 100 memory locations which are conveniently consecutively numbered so that the memory locations of the local memory m1 are 0-99, whilst the memory locations for the local memory m2 are numbered 100-199, etc. A characteristic of the DSM system is that each of the individual computers is able to access each of the memory locations of all the other computers in addition to its own memory locations. This architecture arrangement has the advantage of increasing the total memory available to all the computers, however, it does result in slowing of the computational speed of the multiple computer system because of the need for memory reads and memory writes to take place from one computer to another via the communications system 5.

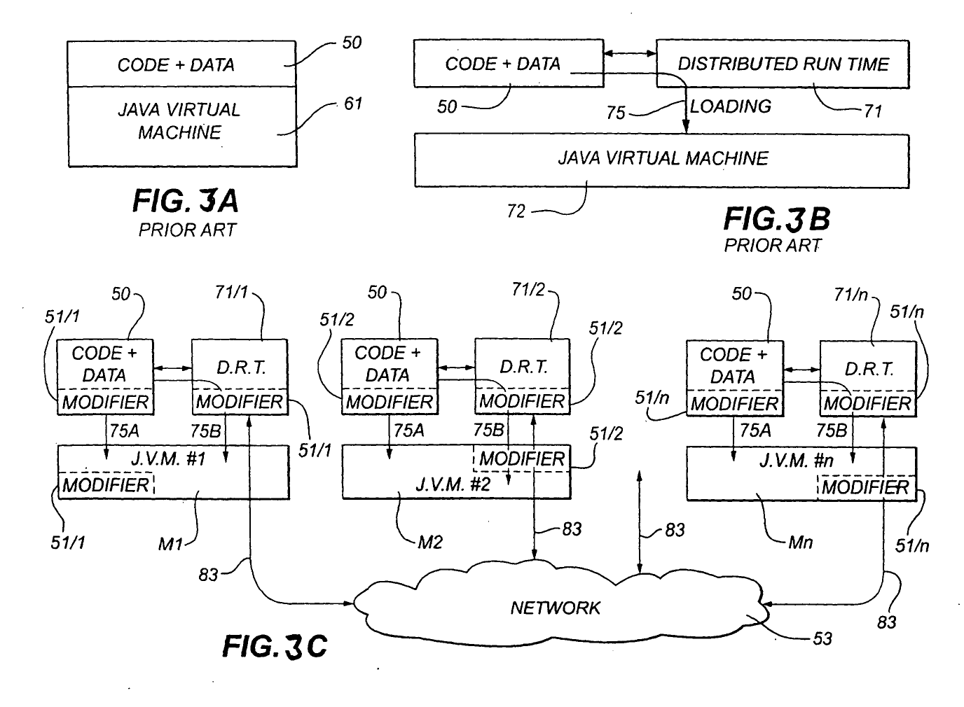

The arrangements illustrated in FIGS. 3A-3C are described with reference to the JAVA language. However, it will be apparent to those skilled in the art that the invention is not limited to this language and, in particular can be used with other languages (including procedural, declarative and object oriented languages) including the MICROSOFT.NET platform and architecture (Visual Basic, Visual C, and Visual C++, and Visual C#), FORTRAN, C, C++, COBOL, BASIC and the like.

It is known in the prior art to provide a single computer or machine (produced by any one of various manufacturers and having an operating system (or equivalent control software or other mechanism) operating in any one of various different languages) utilizing the particular language of the application by creating a virtual machine as illustrated in FIG. 3A.

The code and data and virtual machine configuration or arrangement of FIG. 3A takes the form of the application code 50 written in the JAVA language and executing within the JAVA virtual machine 61. Thus where the intended language of the application is the language JAVA, a JAVA virtual machine is used which is able to operate code in JAVA irrespective of the machine manufacturer and internal details of the computer or machine. For further details, see “The JAVA Virtual Machine Specification” 2^{nd} Edition by T. Lindholm and F. Yellin of Sun Microsystems Inc of the USA which is incorporated herein by reference.

This conventional art arrangement of FIG. 3A is modified by the present applicant by the provision of an additional facility which is conveniently termed a “distributed run time” or a “distributed run time system” DRT 71 and as seen in FIG. 3B.

In FIGS. 3B and 3C, the application code 50 is loaded onto the Java Virtual Machine(s) M1, M2, . . . Mn in cooperation with the distributed runtime system 71, through the loading procedure indicated by arrow 75 or 75A or 75B. As used herein the terms “distributed runtime” and the “distributed run time system” are essentially synonymous, and by means of illustration but not limitation are generally understood to include library code and processes which support software written in a particular language running on a particular platform. Additionally, a distributed runtime system may also include library code and processes which support software written in a particular language running within a particular distributed computing environment. A runtime system (whether a distributed runtime system or not) typically deals with the details of the interface between the program and the operating system such as system calls, program start-up and termination, and memory management. For purposes of background, a conventional Distributed Computing Environment (DCE) (that does not provide the capabilities of the inventive distributed run time or distributed run time system 71 used in the preferred embodiments of the present invention) is available from the Open Software Foundation. This Distributed Computing Environment (DCE) performs a form of computer-to-computer communication for software running on the machines, but among its many limitations, it is not able to implement the desired modification or communication operations. Among its functions and operations the preferred DRT 71 coordinates the particular communications between the plurality of machines M1, M2 . . . Mn. Moreover, the preferred distributed runtime 71 comes into operation during the loading procedure indicated by arrow 75A or 75B of the JAVA application 50 on each JAVA virtual machine 72 or machines JVM#1, JVM#2, . . . JVM#n of FIG. 3C. It will be appreciated in light of the description provided herein that although many examples and descriptions are provided relative to the JAVA language and JAVA virtual machines so that the reader may get the benefit of specific examples, there is no restriction to either the JAVA language or JAVA virtual machines, or to any other language, virtual machine, machine or operating environment.

FIG. 3C shows in modified form the arrangement of the JAVA virtual machines, each as illustrated in FIG. 3B. It will be apparent that again the same application code 50 is loaded onto each machine M1, M2 . . . Mn. However, the communications between each machine M1, M2 . . . Mn are as indicated by arrows 83, and although physically routed through the machine hardware, are advantageously controlled by the individual DRT's 71/1 . . . 71/n within each machine. Thus, in practice this may be conceptionalised as the DRT's 71/1, . . . 71/n communicating with each other via the network or other communications link 53 rather than the machines M1, M2 . . . Mn communicating directly themselves or with each other. Contemplated and included are either this direct communication between machines M1, M2 . . . Mn or DRT's 71/1, 71/2 . . . 71/n or a combination of such communications. The preferred DRT 71 provides communication that is transport, protocol, and link independent.

The one common application program or application code 50 and its executable version (with likely modification) is simultaneously or concurrently executing across the plurality of computers or machines M1, M2 . . . Mn. The application program 50 is written to execute on a single machine or computer (or to operate on the multiple computer system of the abovementioned patent applications which emulate single computer operation). Essentially the modified structure is to replicate an identical memory structure and contents on each of the individual machines.

The term “common application program” is to be understood to mean an application program or application program code written to operate on a single machine, and loaded and/or executed in whole or in part on each one of the plurality of computers or machines M1, M2 . . . Mn, or optionally on each one of some subset of the plurality of computers or machines M1, M2 . . . Mn. Put somewhat differently, there is a common application program represented in application code 50. This is either a single copy or a plurality of identical copies each individually modified to generate a modified copy or version of the application program or program code. Each copy or instance is then prepared for execution on the corresponding machine. At the point after they are modified they are common in the sense that they perform similar operations and operate consistently and coherently with each other. It will be appreciated that a plurality of computers, machines, information appliances, or the like implementing the above arrangements may optionally be connected to or coupled with other computers, machines, information appliances, or the like that do not implement the above arrangements.

The same application program 50 (such as for example a parallel merge sort, or a computational fluid dynamics application or a data mining application) is run on each machine, but the executable code of that application program is modified on each machine as necessary such that each executing instance (copy or replica) on each machine coordinates its local operations on that particular machine with the operations of the respective instances (or copies or replicas) on the other machines such that they function together in a consistent, coherent and coordinated manner and give the appearance of being one global instance of the application (i.e. a “meta-application”).

The copies or replicas of the same or substantially the same application codes, are each loaded onto a corresponding one of the interoperating and connected machines or computers. As the characteristics of each machine or computer may differ, the application code 50 may be modified before loading, or during the loading process, or with some disadvantages after the loading process, to provide a customization or modification of the application code on each machine. Some dissimilarity between the programs or application codes on the different machines may be permitted so long as the other requirements for interoperability, consistency, and coherency as described herein can be maintained. As it will become apparent hereafter, each of the machines M1, M2 . . . Mn and thus all of the machines M1, M2 . . . Mn have the same or substantially the same application code 50, usually with a modification that may be machine specific.

Before the loading of, or during the loading of, or at any time preceding the execution of, the application code 50 (or the relevant portion thereof) on each machine M1, M2 . . . Mn, each application code 50 is modified by a corresponding modifier 51 according to the same rules (or substantially the same rules since minor optimizing changes are permitted within each modifier 51/1, 51/2 . . . 51/n).

Each of the machines M1, M2 . . . Mn operates with the same (or substantially the same or similar) modifier 51 (in some arrangements implemented as a distributed run time or DRT 71 and in other arrangements implemented as an adjunct to the application code and data 50, and also able to be implemented within the JAVA virtual machine itself). Thus all of the machines M1, M2 . . . Mn have the same (or substantially the same or similar) modifier 51 for each modification required. A different modification, for example, may be required for memory management and replication, for initialization, for finalization, and/or for synchronization (though not all of these modification types may be required for all arrangements).

There are alternative implementations of the modifier 51 and the distributed run time 71. For example, as indicated by broken lines in FIG. 1C, the modifier 51 may be implemented as a component of or within the distributed run time 71, and therefore the DRT 71 may implement the functions and operations of the modifier 51. Alternatively, the function and operation of the modifier 51 may be implemented outside of the structure, software, firmware, or other means used to implement the DRT 71 such as within the code and data 50, or within the JAVA virtual machine itself. In one embodiment, both the modifier 51 and DRT 71 are implemented or written in a single piece of computer program code that provides the functions of the DRT and modifier. In this case the modifier function and structure is, in practice, subsumed into the DRT. Independent of how it is implemented, the modifier function and structure is responsible for modifying the executable code of the application code program, and the distributed run time function and structure is responsible for implementing communications between and among the computers or machines. The communications functionality in one arrangement is implemented via an intermediary protocol layer within the computer program code of the DRT on each machine. The DRT can, for example, implement a communications stack in the JAVA language and use the Transmission Control Protocol/Internet Protocol (TCP/IP) to provide for communications or talking between the machines. These functions or operations may be implemented in a variety of ways, and it will be appreciated in light of the description provided herein that exactly how these functions or operations are implemented or divided between structural and/or procedural elements, or between computer program code or data structures, is not important or crucial.

However, in the arrangement illustrated in FIG. 3C, a plurality of individual computers or machines M1, M2 . . . Mn are provided, each of which are interconnected via a communications network 53 or other communications link. Each individual computer or machine is provided with a corresponding modifier 51. Each individual computer is also provided with a communications port which connects to the communications network. The communications network 53 or path can be any electronic signalling, data, or digital communications network or path and is preferably a slow speed, and thus low cost, communications path, such as a network connection over the Internet or any common networking configurations including ETHERNET or INFINIBAND and extensions and improvements, thereto. Preferably, the computers are provided with one or more known communications ports (such as CISCO Power Connect 5224 Switches) which connect with the communications network 53.

As a consequence of the above described arrangement, if each of the machines M1, M2, . . . , Mn has, say, an internal or local memory capability of 10 MB, then the total memory available to the application code 50 in its entirety is not, as one might expect, the number of machines (n) times 10 MB. Nor is it the additive combination of the internal memory capability of all n machines. Instead it is either 10 MB, or some number greater than 10 MB but less than n×10 MB. In the situation where the internal memory capacities of the machines are different, which is permissible, then in the case where the internal memory in one machine is smaller than the internal memory capability of at least one other of the machines, then the size of the smallest memory of any of the machines may be used as the maximum memory capacity of the machines when such memory (or a portion thereof) is to be treated as ‘common’ memory (i.e. similar equivalent memory on each of the machines M1 . . . Mn) or otherwise used to execute the common application code.

However, even though the manner that the internal memory of each machine is treated may initially appear to be a possible constraint on performance, how this results in improved operation and performance will become apparent hereafter. Naturally, each machine M1, M2 . . . Mn has a private (i.e. ‘non-common’) internal memory capability. The private internal memory capability of the machines M1, M2, . . . Mn are normally approximately equal but need not be. For example, when a multiple computer system is implemented or organized using existing computers, machines, or information appliances, owned or operated by different entities, the internal memory capabilities may be quite different. On the other hand, if a new multiple computer system is being implemented, each machine or computer is preferably selected to have an identical internal memory capability, but this need not be so.

It is to be understood that the independent local memory of each machine represents only that part of the machine's total memory which is allocated to that portion of the application program running on that machine. Thus, other memory will be occupied by the machine's operating system and other computational tasks unrelated to the application program 50.

Non-commercial operation of a prototype multiple computer system indicates that not every machine or computer in the system utilises or needs to refer to (e.g. have a local replica of) every possible memory location. As a consequence, it is possible to operate a multiple computer system without the local memory of each machine being identical to every other machine, so long as the local memory of each machine is sufficient for the operation of that machine. That is to say, provided a particular machine does not need to refer to (for example have a local replica of) some specific memory locations, then it does not matter that those specific memory locations are not replicated in that particular machine.

It may also be advantageous to select the amounts of internal memory in each machine to achieve a desired performance level in each machine and across a constellation or network of connected or coupled plurality of machines, computers, or information appliances M1, M2, . . . , Mn. Having described these internal and common memory considerations, it will be apparent in light of the description provided herein that the amount of memory that can be common between machines is not a limitation.

In some arrangements, some or all of the plurality of individual computers or machines can be contained within a single housing or chassis (such as so-called “blade servers” manufactured by Hewlett-Packard Development Company, Intel Corporation, IBM Corporation and others) or the multiple processors (e.g. symmetric multiple processors or SMPs) or multiple core processors (e.g. dual core processors and chip multithreading processors) manufactured by Intel, AMD, or others, or implemented on a single printed circuit board or even within a single chip or chipset. Similarly, also included are computers or machines having multiple cores, multiple CPU's or other processing logic.

When implemented in a non-JAVA language or application code environment, the generalized platform, and/or virtual machine and/or machine and/or runtime system is able to operate application code 50 in the language(s) (including for example, but not limited to any one or more of source-code languages, intermediate-code languages, object-code languages, machine-code languages, and any other code languages) of that platform and/or virtual machine and/or machine and/or runtime system environment, and utilize the platform, and/or virtual machine and/or machine and/or runtime system and/or language architecture irrespective of the machine or processor manufacturer and the internal details of the machine. It will also be appreciated that the platform and/or runtime system can include virtual machine and non-virtual machine software and/or firmware architectures, as well as hardware and direct hardware coded applications and implementations.

For a more general set of virtual machine or abstract machine environments, and for current and future computers and/or computing machines and/or information appliances or processing systems, and that may not utilize or require utilization of either classes and/or objects, the structure, method and computer program and computer program product are still applicable. Examples of computers and/or computing machines that do not utilize either classes and/or objects include for example, the x86 computer architecture manufactured by Intel Corporation and others, the SPARC computer architecture manufactured by Sun Microsystems, Inc and others, the Power PC computer architecture manufactured by International Business Machines Corporation and others, and the personal computer products made by Apple Computer, Inc., and others.

For these types of computers, computing machines, information appliances, and the virtual machine or virtual computing environments implemented thereon that do not utilize the idea of classes or objects, may be generalized for example to include primitive data types (such as integer data types, floating point data types, long data types, double data types, string data types, character data types and Boolean data types), structured data types (such as arrays and records), derived types, or other code or data structures of procedural languages or other languages and environments such as functions, pointers, components, modules, structures, reference and unions. These structures and procedures when applied in combination when required, maintain a computing environment where memory locations, address ranges, objects, classes, assets, resources, or any other procedural or structural aspect of a computer or computing environment are where required created, maintained, operated, and deactivated or deleted in a coordinated, coherent, and consistent manner across the plurality of individual machines M1, M2 . . . Mn.

This analysis or scrutiny of the application code 50 can take place either prior to loading the application program code 50, or during the application program code 50 loading procedure, or even after the application program code 50 loading procedure (or some combination of these). It may be likened to an instrumentation, program transformation, translation, or compilation procedure in that the application code can be instrumented with additional instructions, and/or otherwise modified by meaning-preserving program manipulations, and/or optionally translated from an input code language to a different code language (such as for example from source-code language or intermediate-code language to object-code language or machine-code language). In this connection it is understood that the term “compilation” normally or conventionally involves a change in code or language, for example, from source code to object code or from one language to another language. However, in the present instance the term “compilation” (and its grammatical equivalents) is not so restricted and can also include or embrace modifications within the same code or language. For example, the compilation and its equivalents are understood to encompass both ordinary compilation (such as for example by way of illustration but not limitation, from source-code to object code), and compilation from source-code to source-code, as well as compilation from object-code to object code, and any altered combinations therein. It is also inclusive of so-called “intermediary-code languages” which are a form of “pseudo object-code”.

By way of illustration and not limitation, in one arrangement, the analysis or scrutiny of the application code 50 takes place during the loading of the application program code such as by the operating system reading the application code 50 from the hard disk or other storage device, medium or source and copying it into memory and preparing to begin execution of the application program code. In another arrangement, in a JAVA virtual machine, the analysis or scrutiny may take place during the class loading procedure of the java.lang.ClassLoader.loadClass method (e.g. “java.lang.ClassLoader.loadClass( )”).

Alternatively, or additionally, the analysis or scrutiny of the application code 50 (or of a portion of the application code) may take place even after the application program code loading procedure, such as after the operating system has loaded the application code into memory, or optionally even after execution of the relevant corresponding portion of the application program code has started, such as for example after the JAVA virtual machine has loaded the application code into the virtual machine via the “java.lang.ClassLoader.loadClass( )” method and optionally commenced execution.

Persons skilled in the computing arts will be aware of various possible techniques that may be used in the modification of computer code, including but not limited to instrumentation, program transformation, translation, or compilation means and/or methods.

One such technique is to make the modification(s) to the application code, without a preceding or consequential change of the language of the application code. Another such technique is to convert the original code (for example, JAVA language source-code) into an intermediate representation (or intermediate-code language, or pseudo code), such as JAVA byte code. Once this conversion takes place the modification is made to the byte code and then the conversion may be reversed. This gives the desired result of modified JAVA code.

A further possible technique is to convert the application program to machine code, either directly from source-code or via the abovementioned intermediate language or through some other intermediate means. Then the machine code is modified before being loaded and executed. A still further such technique is to convert the original code to an intermediate representation, which is thus modified and subsequently converted into machine code.

The present invention encompasses all such modification routes and also a combination of two, three or even more, of such routes.

The DRT 71 or other code modifying means is responsible for creating or replicating a memory structure and contents on each of the individual machines M1, M2 . . . Mn that permits the plurality of machines to interoperate. In some embodiments this replicated memory structure will be identical. Whilst in other arrangements this memory structure will have portions that are identical and other portions that are not. In still other arrangements the memory structures are different only in format or storage conventions such as Big Endian or Little Endian formats or conventions.

These structures and procedures when applied in combination when required, maintain a computing environment where the memory locations, address ranges, objects, classes, assets, resources, or any other procedural or structural aspect of a computer or computing environment are where required created, maintained, operated, and deactivated or deleted in a coordinated, coherent, and consistent manner across the plurality of individual machines M1, M2 . . . Mn.

Therefore the terminology “one”, “single”, and “common” application code or program includes the situation where all machines M1, M2 . . . Mn are operating or executing the same program or code and not different (and unrelated) programs, in other words copies or replicas of same or substantially the same application code are loaded onto each of the interoperating and connected machines or computers.

In conventional arrangements utilising distributed software, memory access from one machine's software to memory physically located on another machine typically takes place via the network interconnecting the machines. Thus, the local memory of each machine is able to be accessed by any other machine and can therefore cannot be said to be independent. However, because the read and/or write memory access to memory physically located on another computer require the use of the slow network interconnecting the computers, in these configurations such memory accesses can result in substantial delays in memory read/write processing operations, potentially of the order of 10⁶-10⁷ cycles of the central processing unit of the machine (given contemporary processor speeds). Ultimately this delay is dependent upon numerous factors, such as for example, the speed, bandwidth, and/or latency of the communication network. This in large part accounts for the diminished performance of the multiple interconnected machines in the prior art arrangement.

However, in the present arrangement all reading of memory locations or data is satisfied locally because a current value of all (or some subset of all) memory locations is stored on the machine carrying out the processing which generates the demand to read memory.

Similarly, all writing of memory locations or data is satisfied locally because a current value of all (or some subset of all) memory locations is stored on the machine carrying out the processing which generates the demand to write to memory.

Such local memory read and write processing operation can typically be satisfied within 10²-10³ cycles of the central processing unit. Thus, in practice there is substantially less waiting for memory accesses which involves and/or writes. Also, the local memory of each machine is not able to be accessed by any other machine and can therefore be said to be independent.

The arrangement is transport, network, and communications path independent, and does not depend on how the communication between machines or DRTs takes place. Even electronic mail (email) exchanges between machines or DRTs may suffice for the communications.

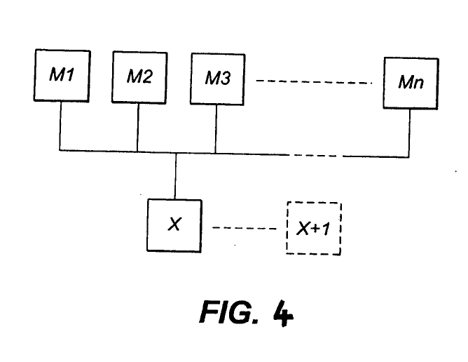

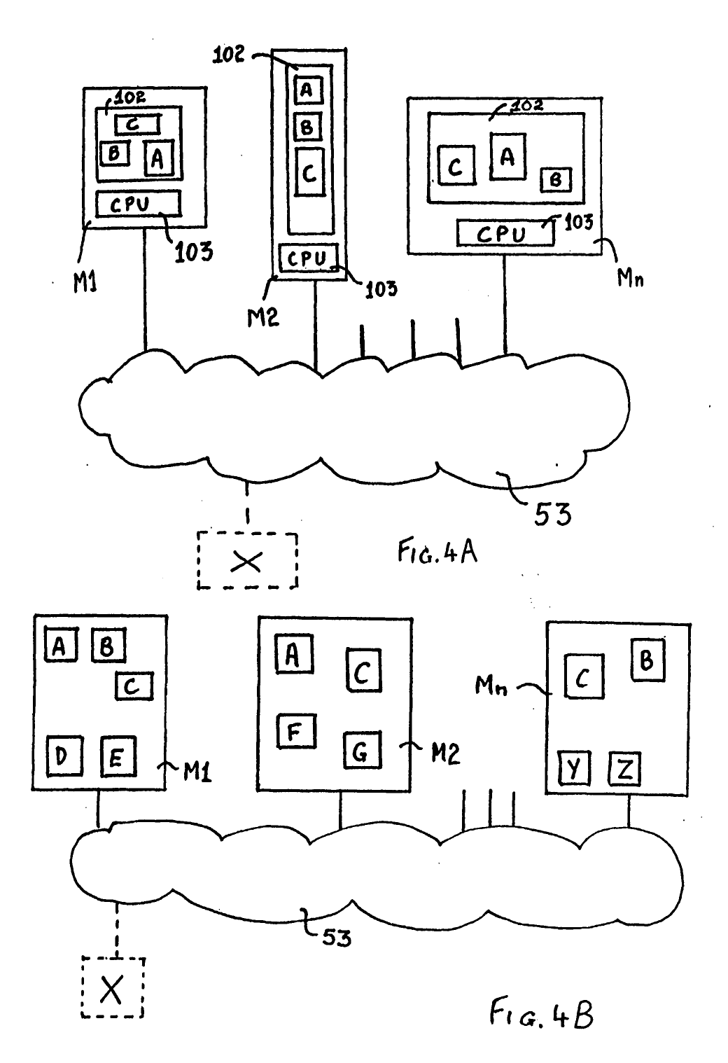

In connection with the above, it will be seen from FIG. 4 that there are a number of machines M1, M2, . . . Mn, “n” being an integer greater than or equal to two, on which the application program 50 of FIG. 3C is being run substantially simultaneously. These machines are allocated a number 1, 2, 3, . . . etc. in a hierarchical order. This order is normally looped or closed so that whilst machines 2 and 3 are hierarchically adjacent, so too are machines “n” and 1. There is preferably a further machine X which is provided to enable various housekeeping functions to be carried out, such as acting as a lock server. In particular, the further machine X can be a low value machine, and much less expensive than the other machines which can have desirable attributes such as processor speed. Furthermore, an additional low value machine (X+1) is preferably available to provide redundancy in case machine X should fail. Where two such server machines X and X+1 are provided, they are preferably, for reasons of simplicity, operated as dual machines in a cluster configuration. Machines X and X+1 could be operated as a multiple computer system in accordance with the present invention, if desired. However this would result in generally undesirable complexity. If the machine X is not provided then its functions, such as housekeeping functions, are provided by one, or some, or all of the other machines.

FIG. 4A is a schematic diagram of a replicated shared memory system. In FIG. 4A three machines are shown, of a total of “n” machines (n being an integer greater than one) that is machines M1, M2, . . . Mn. Additionally, a communications network 53 is shown interconnecting the three machines and a preferable (but optional) server machine X which can also be provided and which is indicated by broken lines. In each of the individual machines, there exists a memory 102 and a CPU 103. In each memory 102 there exists three memory locations, a memory location A, a memory location B, and a memory location C. Each of these three memory locations is replicated in a memory 102 of each machine.

This arrangement of the replicated shared memory system allows a single application program written for, and intended to be run on, a single machine, to be substantially simultaneously executed on a plurality of machines, each with independent local memories, accessible only by the corresponding portion of the application program executing on that machine, and interconnected via the network 53. In International Patent Application No PCT/AU2005/001641 (WO2006/110,937) (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds, a technique is disclosed to detect modifications or manipulations made to a replicated memory location, such as a write to a replicated memory location A by machine M1 and correspondingly propagate this changed value written by machine M1 to the other machines M2 . . . Mn which each have a local replica of memory location A. This result is achieved by the preferred embodiment of detecting write instructions in the executable object code of the application to be run that write to a replicated memory location, such as memory location A, and modifying the executable object code of the application program, at the point corresponding to each such detected write operation, such that new instructions are inserted to additionally record, mark, tag, or by some such other recording means indicate that the value of the written memory location has changed.

An alternative arrangement is that illustrated in FIG. 4B and termed partial or hybrid replicated shared memory (RSM). Here memory location A is replicated on computers or machines M1 and M2, memory location B is replicated on machines M1 and Mn, and memory location C is replicated on machines M1, M2 and Mn. However, the memory locations D and E are present only on machine M1, the memory locations F and G are present only on machine M2, and the memory locations Y and Z are present only on machine Mn. Such an arrangement is disclosed in Australian Patent Application No. 2005 905 582 Attorney Ref 50271 (to which U.S. patent application Ser. No. 11/583,958 (60/730,543) and PCT/AU2006/001447 (WO2007/041762) correspond). In such a partial or hybrid RSM systems changes made by one computer to memory locations which are not replicated on any other computer do not need to be updated at all. Furthermore, a change made by any one computer to a memory location which is only replicated on some computers of the multiple computer system need only be propagated or updated to those some computers (and not to all other computers).

Consequently, for both RSM and partial RSM, a background thread task or process is able to, at a later stage, propagate the changed value to the other machines which also replicate the written to memory location, such that subject to an update and propagation delay, the memory contents of the written to memory location on all of the machines on which a replica exists, are substantially identical. Various other alternative embodiments are also disclosed in the abovementioned prior art.

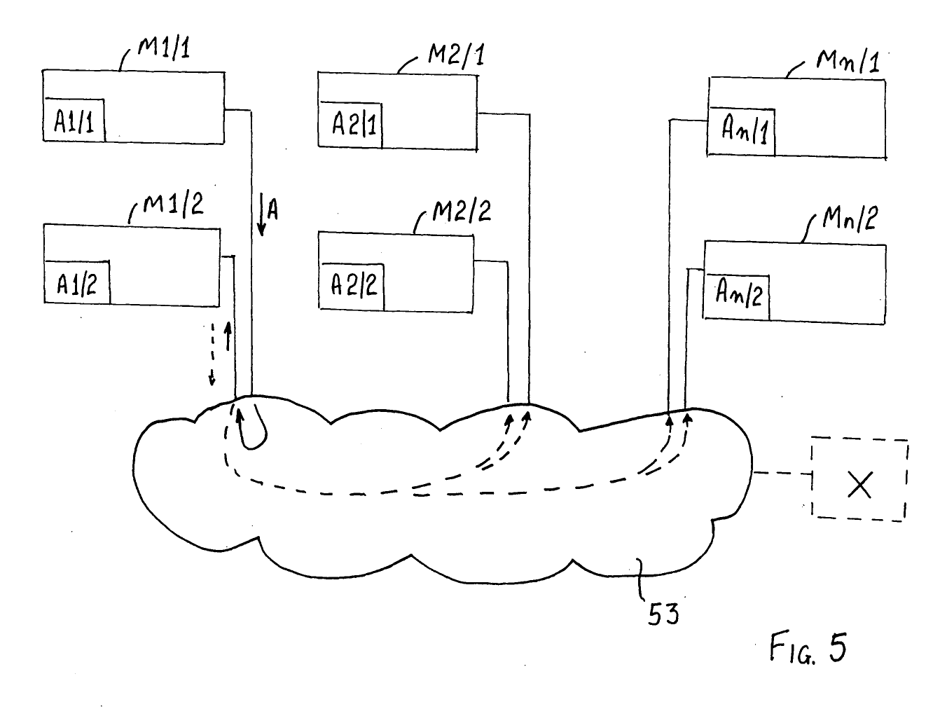

Turning now to FIG. 5, the RSM multiple computer systems of FIGS. 4, 4A, and 4B is modified as illustrated in FIG. 5 by the provision of a second group of “n” machines M1/2, M2/2 . . . Mn/2 which may be said to mirror the first group of “n” machines M1/1, M2/1 . . . Mn/1. As also indicated in FIG. 5, application memory locations/contents/values such as “A” are replicated in each of the first group machines (master machines) M1/1 . . . Mn/1 and are numbered accordingly (as A2/1 . . . An/1). Additionally, the same replicated application memory locations/contents/values such as “A” are also replicated in each second group machine M1/2 . . . Mn/2 (mirror machines), so that machine M1/1 has replicated application memory location/content/value A1/1 and the equivalent replicated application memory location/content/value on mirror machine M1/2 is replicated application memory location/content/value A1/2 and so on. Apart from minor delays in updating data, the contents or value of each of the memory locations A (e.g. memory locations A1/1 and A1/2) are substantially similar.

There is at least one communications link between each of the machines of the first group M1/1, M2/1, . . . Mn/1 and at least one communications network 53, as well as at least one communications link between each of the corresponding machines of the second group M2/1, M2/2, . . . Mn/2 and at least one communications network 53. Preferably, each of the machines of the first group and each of the machines of the second group are connected to the same one or more communications networks 53.

In one embodiment the M1/1 . . . Mn/1 machines each use a “virtual memory page faults” procedure, or similar to ensure that every time that machine Mn/1 writes to a replicated application memory location/content/value, the content or value of that write operation (that is, the updated value of the written-to replicated application memory location) is subsequently updated to the corresponding mirror machine Mn/2. Alternatively, each machine M1/1 . . . Mn/1 may use any “tagging” (or similar “marking”, “alerting”) means or methods to record or indicate that a write to one or more replicated application memory locations/contents/values has taken place, and that in due course, the identified replicated application memory locations which have been recorded or identified as having been written to, are to have their new value in turn propagated to all other corresponding replica application memory locations/contents/values on one or more other member machines of the replicated shared memory arrangement or other operating plurality of machines. One such tagging method is disclosed in the International Patent Application Nos. PCT/AU2005/001641 (WO2006/110937) (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds and PCT/AU2006/000532 (WO2006/110957) (Attorney Ref 5027F-D2-WO). Ultimately however, how the writes are detected is not important, what is important is that they be detected and in due course the written or modified memory contents or value is sent to machine Mn/2.

Preferably, the replica memory update transmissions sent by a first group machine (such as machine M1/1) to a second group machine (such as machine M1/2), comprises an identifier and updated value of the written-to replicated application memory location. International Patent Application Nos. PCT/AU2005/001641 (WO2006/110937) (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds and PCT/AU2006/000532 (WO2006/110957) (Attorney Ref 5027F-D2-WO), disclose an arrangement of replica memory update transmissions comprising replica memory location/content identifiers and associated update values, and the contents of each specification of the abovementioned prior application(s) are hereby incorporated into the present specification by cross reference for all purposes.

In a further preferred arrangement, the replica memory update transmissions sent by a first group machine (such as machine M1/1) to a second group machine (such as machine M1/2) further comprises at least one “count value” and/or “resolution value” associated with one or more replica memory location/content identifiers and associated update values.

The data protocol or data format which is used in both FIG. 3AA and FIG. 4AA to transmit information between the various machines enables bundles or packets of data to be transmitted or received out of the sequence in which they were created. One way of doing this is to utilize the contention detection, recognition and data format techniques described in International Patent Application No. PCT/AU2007/______ entitled “Advanced Contention Detection” (Attorney Reference 5027T-WO) lodged simultaneously herewith and claiming priority of Australian Patent Application No. 2006 905 527 entitled “Advanced Contention Detection” (Attorney reference number 5027T) lodged concurrently with the present application, (and to which U.S. Provisional Patent Application No. 60/850,711 corresponds). The contents of both the above specifications are hereby incorporated in the present specification in full for all purposes.

Briefly stated, the abovementioned data protocol or message format includes both the address of a memory location where a value or content is to be changed, the new value or content, and a count number indicative of the position of the new value or content in a sequence of consecutively sent new values or content.

Thus a sequence of messages are issued from one or more sources. Typically each source is one computer of a multiple computer system and the messages are memory updating messages which include a memory address and a (new or updated) memory content.

Thus each source issues a string or sequence of messages which are arranged in a time sequence of initiation or transmission. The problem arises that the communication network 53 cannot always guarantee that the messages will be received in their order of transmission. Thus a message which is delayed may update a specific memory location with an old or stale content which inadvertently overwrites a fresh or current content.

In order to address this problem each source of messages includes a count value in each message. The count value indicates the position of each message in the sequence of messages issuing from that source. Thus each new message from a source has a count value incremented (preferably by one) relative to the preceding messages. Thus the message recipient is able to both detect out of order messages, and ignore any messages having a count value lower than the last received message from that source. Thus earlier sent but later received messages do not cause stale data to overwrite current data.

As explained in the abovementioned cross referenced specifications, later received packets which are later in sequence than earlier received packets overwrite the content or value of the earlier received packet with the content or value of the later received packet. However, in the event that delays, latency and the like within the network 53 result in a later received packet being one which is earlier in sequence than an earlier received packet, then the content or value of the earlier received packet is not overwritten and the later received packet is effectively discarded. Each receiving computer is able to determine where the latest received packet is in the sequence because of the accompanying count value. Thus if the later received packet has a count value which is greater than the last received packet, then the current content or value is overwritten with the newly received content or value. Conversely, if the newly received packet has a count value which is lower than the existing count value, then the received packet is not used to overwrite the existing value or content. In the event that the count values of both the existing packet and the received packet are identical, then a contention is signalled and this can be resolved.

This resolution requires a machine which is about to propagate a new value for a memory location, and provided that machine is the same machine which generated the previous value for the same memory location, then the count value for the newly generated memory is not increased by one (1) but instead is increased by more than one such as by being increased by two (2) (or by at least two). A fuller explanation is contained in the abovementioned cross referenced provisional PCT specification.

Preferably also, the replica memory update transmissions sent by a first group machine (such as machine M1/1) to a second group machine (such as machine M1/2) further includes a list of one or more addresses or other identifiers or identifying means of one or more other first group machine(s) to which the replica memory update transmission is to be directed by the paired second group machine (e.g. machine M1/2). Preferably, such list of one or more addresses or other identifiers or identifying means includes those machines on which corresponding replica application memory location(s)/content(s)/value(s) of the replica memory update transmission reside, and excludes those machines in which no corresponding replica application memory location(s)/content(s)/value(s) of the replica memory update transmission reside. Preferably then, the paired second group machine (e.g. machine M1/2) upon receipt of a replica memory update transmission from its paired first group machine (e.g. machine M1/1), utilises the associated list of one or more addresses or other identifiers or identifying means of the received replica memory update transmission to either forward the received transmission to the machines identified by such list, or alternatively generate a new corresponding replica memory update transmission to be sent to the machines identified by such list. Alternatively, such above described list or table may also include addresses or other identifiers or identifying means of one or more of the second group machines.

When the second group machine (e.g. machine M1/2) proceeds to send a replica memory update transmission to one or more identified first group machines of the above described list in which only first group machines are identified, the second group machine also proceeds to send the same replica memory update transmission to each paired second group machine of the identified first group machines. Alternatively, the second group machine may send a new corresponding replica memory update transmission for the second group machines, in addition to the corresponding but different replica memory update transmission sent to the first group machines. Preferably however, the same replica memory update transmission is sent to both of the identified first group machines, and the corresponding paired second group machines.

In the event that the operation of machine M1/1 causes the content or value of the replicated application memory location/content/value A to be changed/updated (such as for example, by the application program and/or application program code writing/storing a new value of “99” to replica application memory location “A”), the DRT of machine M1/1 causes the new contents or value of replicated application memory location “A” (that is, the updated value “99”) to be transmitted in a replica memory update transmission 501 from machine M1/1 via the communications network 53 to the machine M1/2. Preferably the replica memory update transmission 501 comprises the identity (or other identifier) of replicated application memory location “A”, and their associated updated value of replica application memory location “A” (that is, the updated value “99”). Preferably additionally, the replica memory update transmission 501 further comprises at least one “count value” and/or “resolution value”, and which is to be associated with the updated value of replica memory location “A”. Machine M1/2 upon receipt of replica memory update transmission 501, updates its own corresponding replica application memory location/content/value A1/2 with the received updated value “99”, and then has its DRT transmit either the received replica update transmission 501 (shown as replica update transmission 502), or alternatively transmit a new replica memory update transmission (comprising the identity and new content(s)/value(s), and preferably an associated “count value” and/or “resolution value”, of replicated memory location A, of the received replica update transmission 501) to each of the other machines M2/1 . . . Mn/1, M2/2 . . . Mn/2. This communication is indicated by broken arrows in FIG. 5. The updating techniques and equipment are as described in the above-mentioned cross-referenced applications and are preferably implemented by the computer code disclosed therein

Each of the “mirror” machines M1/2, M2/2 . . . Mn/2 has loaded on it the same application program 50 (and preferably the same portion of the same application program 50), and associated replicated application program memory locations/contents/values (such as replicated application memory location “A”), as its corresponding machine in the first group of machines M1/1, M2/1 . . . Mn/1. Preferably however, this portion of the application program stored on the mirror group of machines is not being executed but is merely available to commence execution in the event of failure of the corresponding machine in the first group.

In addition, each of the “mirror” machines of the second group is preferably updated from time to time with advice that the corresponding computer of the first group in executing its portion of the application program 50 has reached certain “milestone” instructions.

In a simple embodiment of this “milestone” technique, from time to time each of the first group of machines (e.g. Mn/1) halts execution of the application program code (that is, the executing code and/or threads of application program 50), and for one or more (and preferably each) thread records the program counter and associated state data (such as for example but not restricted to one or more of the application's thread invocation stack(s), register memory locations/values/contents, and method frames). This information is then sent to the corresponding mirror machine Mn/2, preferably in a similar manner of transmission as that utilised by replica memory update transmissions (such as for example replica memory update transmission 501 or 502). Then the first group machine Mn/1 resumes execution. Alternatively, a spare thread can capture the current status and associated state data of one or more executing threads without halting such executing threads. This simple embodiment may not work with all application programs but will work with a substantial number or proportion of such application programs. In a further embodiment, both “milestones” and replica memory update transmissions are collected and/or sent at the same time (i.e. at the time of the code execution halt, or the execution halt is timed to coincide with one or more of the replica memory update transmissions/messages) so that machine Mn/2 receives both together (though not necessarily in a single message, frame, packet, cell, or other single transmission unit). Thus, “together” in this instance can be a single message containing both items of data, or two or more messages closely spaced in time.

In the event that a machine, for example machine M1/1 should fail, then several consequences flow. Firstly, replica memory update transmissions by all other machines to the failed machine (e.g. machine M1/1) are preferably discontinued, whilst replica memory update transmissions by all other machines continue to be sent as normal to the unfailed mirror machine M1/2. Preferably, all other machines are updated of the failure of machine M1/1, and thereafter preferably only send replica memory update transmission to the single unfailed one of the two paired machines (that is, machine M1/2 in the above example). Thus machine M1/2 which is still operative is continually updated with replica memory update transmission by all other machines even though no further replica memory update transmissions are sent to failed machine M1/1, or alternatively replica memory update transmissions/messages sent to failed machine M1/1 are of no effect. Secondly and optionally, machine M1/2 is able to initiate execution of the portion of the application program previously executed by machine M1/1 commencing at the position of the last “milestone” state data received by machine M1/2 from machine M1/1 prior to failure. In this connection machine M1/2 utilizes both the same application program code and the replicated application memory locations/contents/values of machine M1/1 which are replicated in machine M1/2.

The above-mentioned failure is able to be detected by a conventional detector attached to each of the application program running machines and reporting to machine X, for example.

One such detector arrangement may be through the use of the Simple Network Management Protocol (SNMP) of a switch interconnecting each of the plural machines. This is essentially a small program which operates in the background of the switch and provides a specified output signal in the event that failure of a communications link interconnecting a machine (such as a disconnected network cable) is detected. Machine X may either then “poll” the switch using the SNMP protocol to enquire about the network connection status of each of the machines, or alternative receive a message or signal from the SNMP equipped switch informing machine X when a link failure of an individual machine has occurred (such as for example, a network cable being cut or disconnected).

A second alternative detector arrangement to sense failure of a machine is by machine X “polling” each machine directly at regular intervals. For example, machine X can interrogate each of the other machines M1/1, M2/1, . . . Mn/1 (and potentially also machines M1/2 . . . Mn/2) in turn requesting a reply. If no reply is forthcoming after a predetermined time, or after a small number of “reminders” are sent, also without reply, the non-responding machine is pronounced “dead”/“failed”.

Alternatively, or additionally, each of the machines M1/1, . . . Mn/1 (and potentially also machines M1/2 . . . Mn/2) can at regular intervals, say every 30 seconds, send a predetermined message to machine X (or to all other machines in the absence of a server) to say that all is well. In the absence of such a message the machine can be presumed “dead”/“failed” or can be interrogated (and if it then fails to respond) is pronounced “dead”/“failed”.

Further methods include looking for a turn on event in an uninterruptible power supply (UPS) used to power each machine which therefore indicates a failure of mains power. Similarly, conventional switches such as those manufactured by CISCO of California, USA include a provision to check either the presence of power to a communications network cable, and whether the network cable is disconnected.

In some circumstances, for example for enhanced redundancy or for increased bandwidth, each individual machine can be “multi-peered” which means there are two or more links between the machine and the communications network 53. An SNMP product which provides two options in this circumstance-namely wait for both/all links to fail before signalling machine failure, or signal machine failure if any one link fails, is the 12 Port Gigabit Managed Switch GSM 7212 sold under the trade marks NETGEAR and PROSAFE.

A disadvantage of the arrangement illustrated in FIG. 5 is that there is considerable traffic on each of the interconnections between the second group of machines M1/2, M2/2 . . . Mn/2 and the communications network 53 since, as indicated by the two arrows pointing in opposite directions for machine M1/2, it is both receiving messages from machine M1/1 and sending messages to all other machines. Restated, the communications link or port of machine M1/2 both receives the replica memory update transmissions of machine M1/1, and sends such received transmissions to all other machines M2/1 . . . Mn/1 and M2/2 . . . Mn/2. As a consequence, there is a requirement for considerable bandwidth in the individual communication links interconnecting each machine generally, and each mirror machine M1/2 . . . Mn/1 specifically, to the communication network 53.

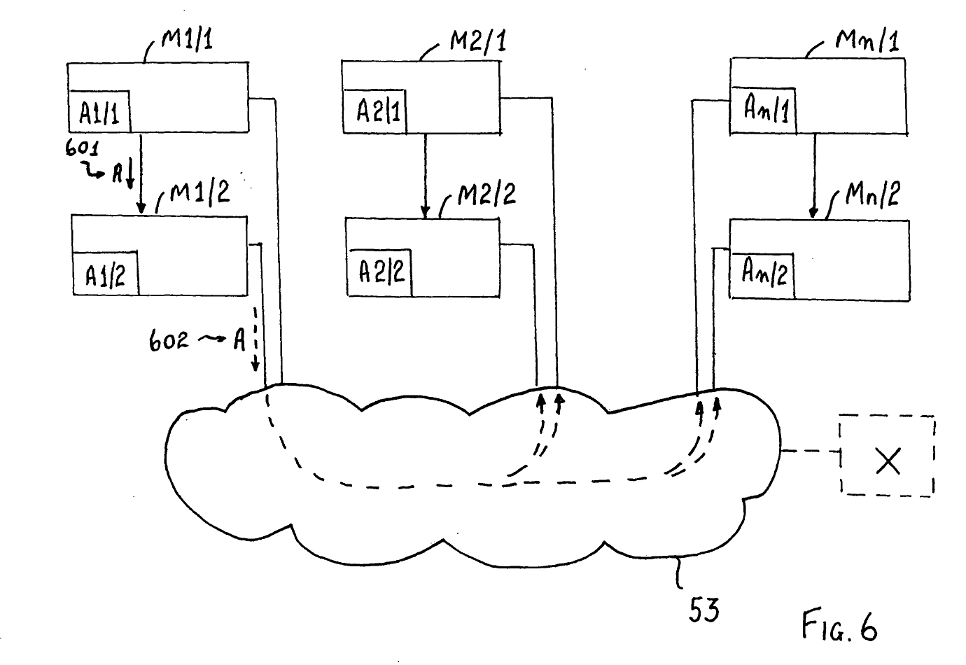

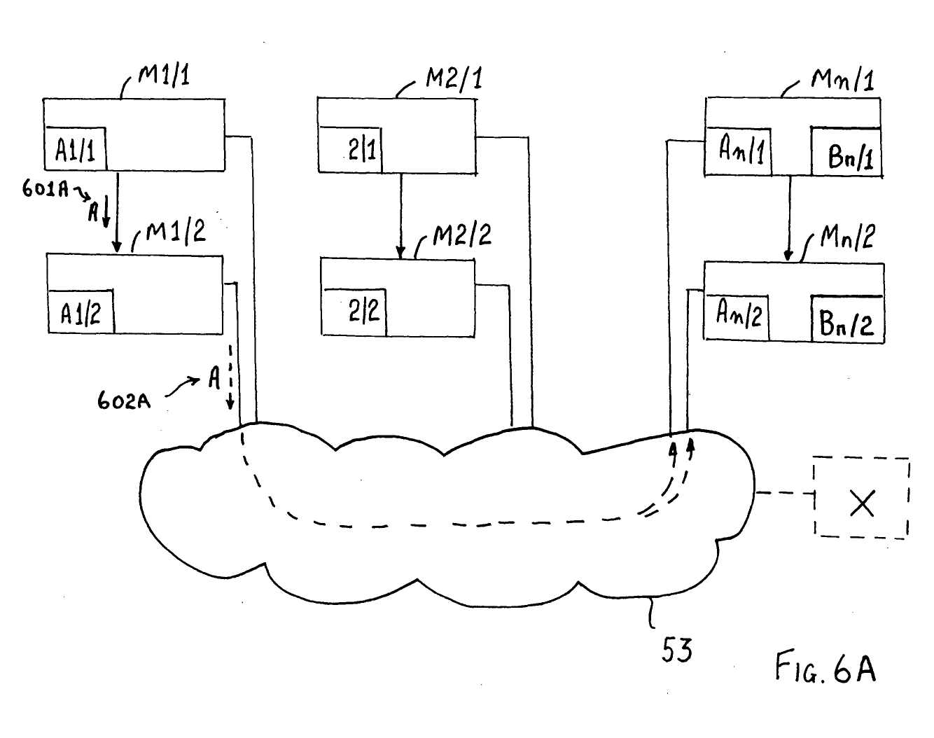

In accordance with a preferred embodiment of the present invention, better utilization of bandwidth is achieved in accordance with the arrangement illustrated in FIG. 6 in which there is a direct communications link between each of the machines of the first group M1/1, M2/1 . . . Mn/1 and each of the corresponding machines of the second group M1/2, M2/2 . . . Mn/2. In the arrangement illustrated in FIG. 6, in the event that machine M1/1 changes/updates the contents or value of replicated application memory location/content/value “A”, then as indicated by transmission 601 of FIG. 6, this information is transmitted directly from machine M1/1 to M1/2 via such direct communications link. As in the previous embodiment, machine M1/2 thereafter receives and processes replica memory update transmission 601 as described above for transmission 501 of FIG. 5. Thus, following receipt of transmission 601, transmission 602 is sent via the communications network 53 (either taking the form of the original transmission 601, or alternatively a new transmission generated by machine M1/2) of the updated contents or value of replica application memory location/content/value “A” received by machine M1/2 via transmission 601, and sent to each of the remaining machines M2/1 . . . Mn/1, M2/2 . . . Mn/2 in accordance with the above description for replica memory update transmission 502.

The arrangement in FIG. 6 has one significant advantage. The demands on bandwidth for the interconnections between the mirroring machines of the second group and the communications network 53 are reduced because replica memory update transmission 601 and 602, both comprising the same updated replica application memory contents/values of replicated memory location “A”, are not received and sent respectively on the same communications link (and therefore, the same updated replica application memory contents/values of replicated application memory location “A” are not being sent twice (in opposite directions) on the same communications link).

In this connection “direct” can include within its scope any link which avoids the network 53, or specialised linkages through the network 53. Additionally, such a “direct” connection can further include any other arrangement (such as multiple links between mirror machines M1/2 . . . Mn/2 and the network 53) in which a single replica memory update transmission (and/or associated updated content(s)/value(s)) of a master machine (such as machine M1/1) does not traverse the same communications link of the corresponding mirror machine (e.g. machine M1/2) more than once. As an example of the latter, if machines M1/1 and M1/2 are each provided with a dual port connection to the network 53, then one port of each dual port can provide the direct connection.

Turning now to FIG. 6A, a modified example of FIG. 6 is shown. Specifically indicated in FIG. 6A is an arrangement of partially replicated application memory locations/contents/values, where replicated application memory location/content/value “A” is not replicated on all machines, but instead only machines M1/1 (and consequently also M1/2) and Mn/1 (and consequently also Mn/2). Also indicated is a partially replicated application memory location “B”, which is indicated to be replicated on machines M2/1 (and consequently also M2/2) and Mn/1 (and consequently also Mn/2). Specifically indicated is replica memory update transmission 601A which corresponds to replica memory update transmission 601 of FIG. 6. Also shown is replica memory update transmission 602A which corresponds to replica memory update transmission 602 of FIG. 6, however unlike transmission 602 which was sent to all machines M2/1 . . . Mn/1 and M2/2 . . . Mn/2, transmission 602A is only sent to those machines on which a corresponding replica application memory location/content/value “A” resides—that is, machines Mn/1 and Mn/2. Thus, as illustrated in FIG. 6A, replica memory update transmissions sent by machine M1/2 (or more generally, any/all mirror machines of the second group) are preferably only sent to those machines of the first and second groups on which a corresponding replica memory location/value/content resides. As a consequence of this preferred arrangement, superfluous or unnecessary replica memory update transmissions are not sent to machines of either the first group or second group on which corresponding replica memory location(s)/content(s)/value(s) are not resident or do not exist, thereby conserving bandwidth of the network 53.

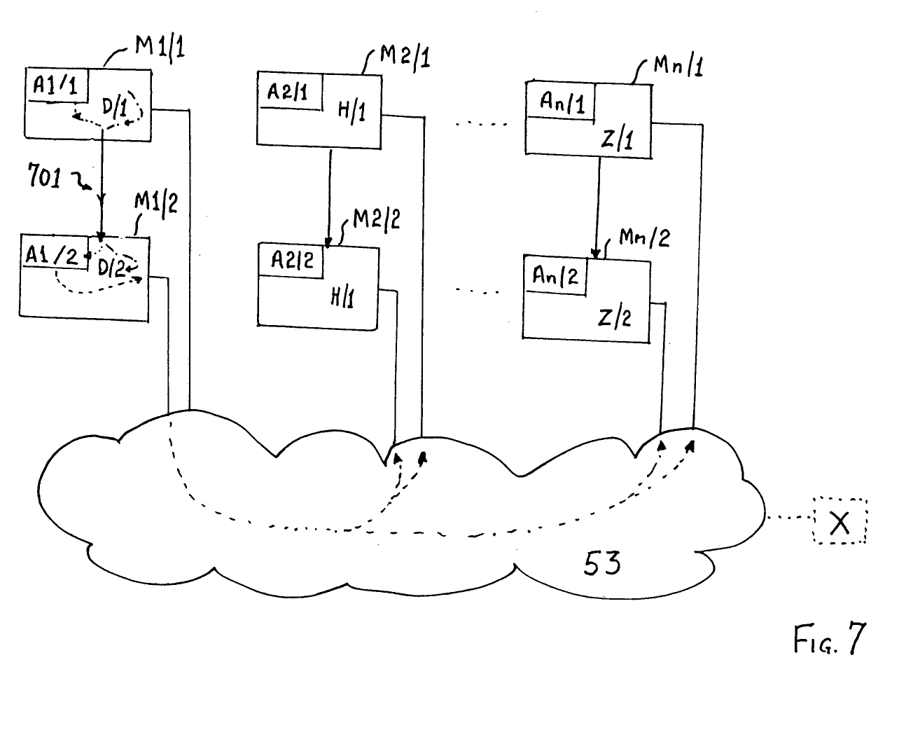

Turning now to FIG. 7, a still further embodiment based upon the architecture of FIG. 6 is illustrated. In this embodiment, the application memory of each of the machines of the multiple computer system is modified so that there is hybrid replicated shared memory. That is to say, each of the machines has two distinct regions of application memory. One region is a replicated region containing replicated application memory locations/contents/values such as “A” each of which is replicated on either each machine, or alternatively replicated on at least one other machine but not all machines as was shown in FIG. 6A. The other portion of application memory is an independent portion which contains application memory locations/contents/values which are not replicated on any other machine, and are used only by the local first machine and are not required for the execution of the application program portions being executed on the other first machines. Thus application memory location/content/value “D” is unique to machine M1/1 and is replicated only on machine M1/2 for the purposes of redundancy. Similarly, application memory location/content/value “H” on machine M2/1 is unique to the second machine and is again replicated only on machine M2/2 for the purposes of redundancy, and so on.

Thus, in the embodiment illustrated in FIG. 7, in the event that a replicated application memory location/content/value is updated, then as in FIG. 6 or 6A, the new/changed contents/value for replica application memory location “A” are transmitted directly by machine M1/1 to machine M1/2 and the DRT of that machine transmits such received new/changed replica contents/values (either as a retransmission of the received transmission of machine M1/1, or as a new transmission comprising the received new/changed replica contents/values) via the communications link 53 to all the other machines M2/1 . . . Mn/1, M2/2 . . . Mn/2. This is indicated by transmission 701 (and indicated by the broken arrows) of FIG. 7.

Preferably however, in the event that an independent application memory location such as “D” (that is, an application memory location/content/value which is not replicated on any other machine of the first group) is changed/updated by machine M1/1 (such as written-to by the executing portion of the application program of machine M1/1), then this updated value is transmitted directly to machine M1/2 also as indicated by replica memory update transmission 701 (and the dot-dash arrows) of FIG. 7. Such transmission 701 of the updated/changed value of an independent application memory location preferably takes the form of a regular replica memory update transmission (such as transmission 601 of FIG. 6), and comprising the identity and updated value of the written-to independent application memory location. However, unlike either of transmissions 601 or 601A of FIGS. 6 and 6A respectively, upon receipt of such a replica memory update transmission for a independent application memory location (that is, an application memory location/content/value which is not replicated on any other machine of the first group), the receiving machine of the second group (such as for example machine M1/2) does not forward either the received transmission or the associated updated value to any other machine (such as machines M2/1 . . . Mn/1 and M2/2 . . . Mn/2).

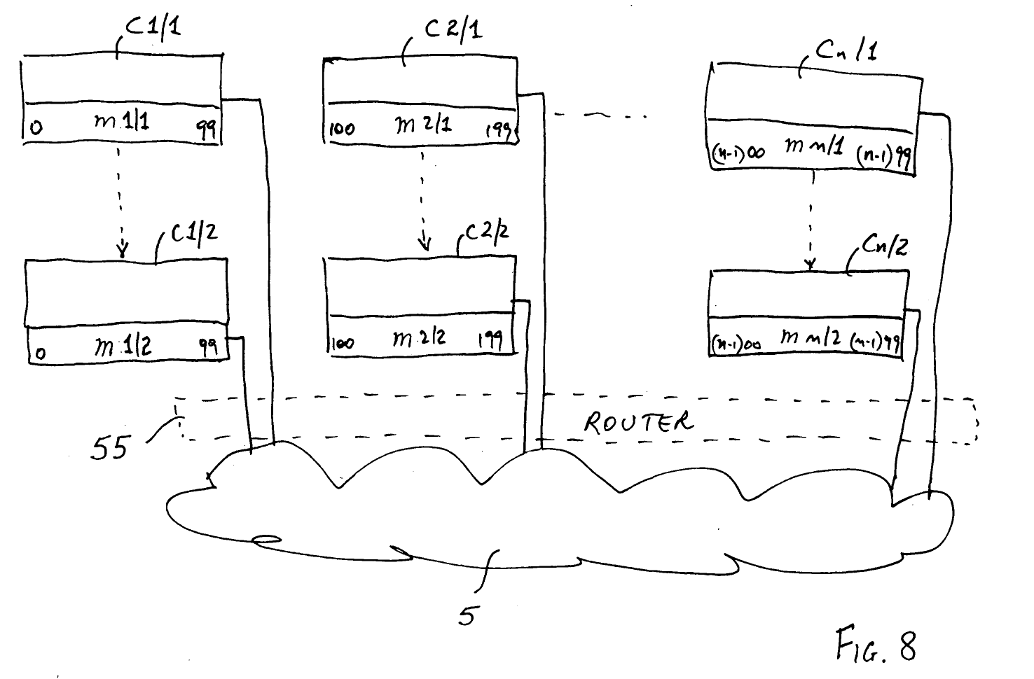

The present invention is also applicable to multiple computer systems incorporating Distributed Shared Memory (DSM). An embodiment in this connection is illustrated in FIG. 8. Here, a first group of “n” computers C1/1, C2/1 . . . Cn/1 are mirrored by means of a second group of computers C1/2, C2/2 . . . Cn/2. For the purposes of explanation, and not to limit the invention in any way, it is assumed that each computer in the first group has, in the manner indicated in FIG. 2, 100 memory locations in its memory so that the memory m1/1 of computer C1/1 has memory locations 0-99, whilst the memory m2/1 of computer C2/1 has memory locations 100-199, and so on. Each group of memory locations are replicated in the corresponding computer of the second group. All of the computers are interconnected by means of the communication system 5. Preferably, a router 55 is provided to correctly route communications between the computers. If desired, as in the embodiment of FIGS. 6 & 7, a direct communication link between each of the computers of the first group and the corresponding computer of the second group can be provided, as indicated by broken lines in FIG. 8.

In the arrangement of FIG. 8 read operations (reads) from memory are executed by reading the memory of the computers of the first group. However, write operations (writes) to memory are made both to the computers of the first group and also the computers of the second group. In the event of failure of one of the computers in the first group, then the corresponding memory locations can be accessed by the memory read request being rerouted to the corresponding computer of the second group. This is able to be handled by the router 55 as a matter of routine, merely by the router 55 being arranged to send a request for information to the corresponding computer of the second group in the event that the computer of the first group fails to respond.

In addition, in the event of failure of, say, computer C2/1, then computer C2/2 can undertake the tasks previously carried out by computer C2/1 and so the multiple computer system can be provided with the desired redundancy.

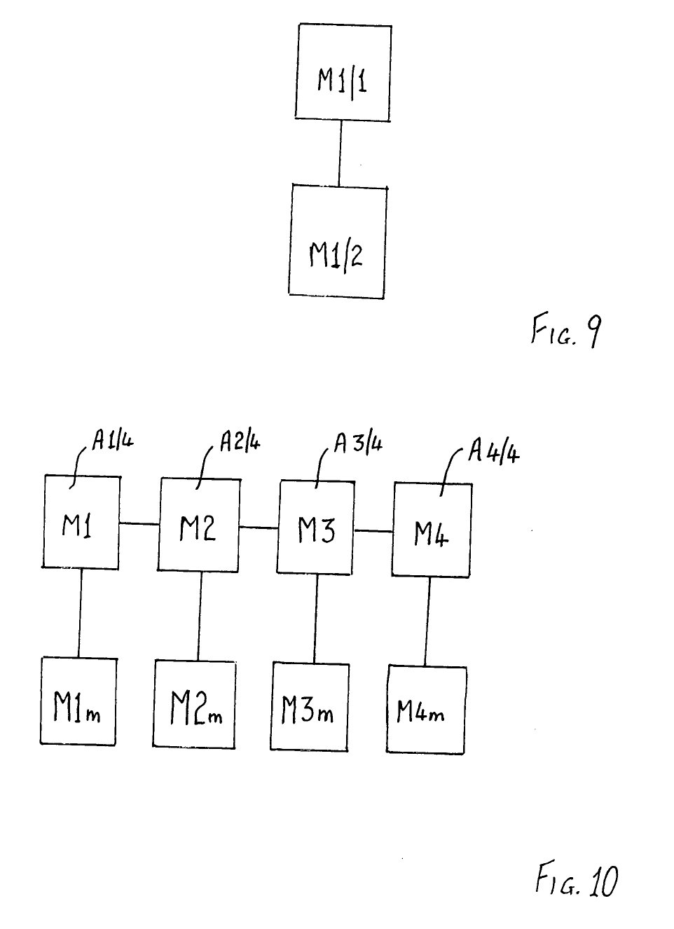

The present invention is also applicable to a single computer. As seen in FIG. 9, a single computer M1/1 can be a pre-existing computer and, in particular, can be a large and expensive computer operating the fundamental enterprise software of a substantial organisation such as a bank, merchant or manufacturer. In order to provide redundancy an similar or equivalent or identical machine M1/2 is purchased and machine M1/2 is operated as the mirror machine (that is, the machine of the second group), and machine M1/1 is operated as the master machine (that is, the machine of the first group). Each machine M1/1 and M1/2 then a same application program as described above. Additionally, one or more application memory locations/contents/values of the first group machine (that is, machine M1/1) are replicated on the second group machine (that is, machine M1/2) and updated to remain substantially similar, as described above. Preferably such application program is written to only execute on a single machine M1/1 and is written or operates in such a manner as to be completely intolerant of failure of machine M1/1 when operated without the methods of the present invention.

Using the techniques referred to above, the updated replicated application memory locations/contents/values of machine M1/1, and preferably associated execution “milestones” state data of each application thread of machine M1/1, are transmitted and updated onto the mirror machine M1/2 in accordance with the above described methods and arrangements. In the event that machine M1/1 should fail, then by utilising the updated replicated application memory locations/contents/values of machine M1/2, the application program (including the application memory locations/contents/values) is provided with at least some measure of redundancy. Additionally, in the event that machine M1/1 should fail and “milestone” state data has been transmitted from machine M1/1 to machine M1/2 prior to failure of machine M1/1, then machine M1/2 is able to resume execution of each application thread at its last received “milestone” state data and by utilising the updated replicated application memory locations/contents/values of machine M1/2, the application program (including the application memory locations/contents/values) is provided with a substantial measure of redundancy.

In another, but similar, embodiment as illustrated in FIG. 10, four computers M1, M2, M3 and M4 are arranged to operate as a cluster. At considerable expense, the application program such as that running on the single machine M1/1 of FIG. 9, has been partitioned into four discrete parts A1/4, A2/4, A3/4 and A4/4. Part A1/4 is written to only operate on machine M1, part A2/4 is written to only operate on machine M2, and so on for each of the other parts and machines. Generally each part is tolerant of failure of a machine other than the one it operates on, but is not tolerant of failure of its own machine.

In FIG. 10, the arrangement of FIG. 9 is reproduced for each of the machines M1-M4 so that each of these machines has its own corresponding mirror machine M1m-M4m respectively. Thus in the event that any one, or more, of the machines M1-M4 should fail, then the corresponding one, or more, mirror machines M1m-M4m steps in and resumes execution at the last “milestone” received from its corresponding failed machine. It will be appreciated that other embodiments having different numbers of machines may be utilised and configured, and that the numbers of machines and/or parts described herein are for the purpose of example, and that the invention is not limited to any particular number of machines or parts.

Those skilled in the computing and/or programming arts will be aware that most computer programs which are written to be operated by a single computer comprising a single memory, are written with the programmer paying no heed to the possibility of such a single computer (machine) failure. Thus in the event that the (single) computer running the program should fail, it is necessary to re-start the computer at the beginning of the program and all the previous computing time is effectively lost.

However, for some applications, the programmer(s) is/are aware of the economic cost of lost computing time and so insert into the programs various devices such as checkpoints which enable the program to be restarted mid-way in the event of computer failure. This is an onerous programming task and therefore undesirable.

The advantage of the various above described arrangements is that programs in the first category programs need not be modified to be in the second category but can instead be run in the knowledge that failure of a single machine, or even depending upon the embodiment multiple machines, will not mean that the program needs to be restarted at the beginning and thus there is no substantial loss of computing time or application data and memory.

The foregoing describes only some embodiments of the present invention and modifications, obvious to those skilled in the art, can be made thereto without departing from the scope of the present invention. For example, reference to JAVA includes both the JAVA language and also JAVA platform and architecture.

In all described instances of modification, where the application code 50 is modified before, or during loading, or even after loading but before execution of the unmodified application code has commenced, it is to be understood that the modified application code is loaded in place of, and executed in place of, the unmodified application code subsequently to the modifications being performed.

Alternatively, in the instances where modification takes place after loading and after execution of the unmodified application code has commenced, it is to be understood that the unmodified application code may either be replaced with the modified application code in whole, corresponding to the modifications being performed, or alternatively, the unmodified application code may be replaced in part or incrementally as the modifications are performed incrementally on the executing unmodified application code. Regardless of which such modification routes are used, the modifications subsequent to being performed execute in place of the unmodified application code.

It is advantageous to use a global identifier is as a form of ‘meta-name’ or ‘meta-identity’ for all the similar equivalent local objects (or classes, or assets or resources or the like) on each one of the plurality of machines M1, M2 . . . Mn. For example, rather than having to keep track of each unique local name or identity of each similar equivalent local object on each machine of the plurality of similar equivalent objects, one may instead define or use a global name corresponding to the plurality of similar equivalent objects on each machine (e.g. “globalname7787”), and with the understanding that each machine relates the global name to a specific local name or object (e.g. “globalname7787” corresponds to object “localobject456” on machine M1, and “globalname7787” corresponds to object “localobject885” on machine M2, and “globalname7787” corresponds to object “localobject111” on machine M3, and so forth).

It will also be apparent to those skilled in the art in light of the detailed description provided herein that in a table or list or other data structure created by each DRT 71 when initially recording or creating the list of all, or some subset of all objects (e.g. memory locations or fields), for each such recorded object on each machine M1, M2 . . . Mn there is a name or identity which is common or similar on each of the machines M1, M2 . . . Mn. However, in the individual machines the local object corresponding to a given name or identity will or may vary over time since each machine may, and generally will, store memory values or contents at different memory locations according to its own internal processes. Thus the table, or list, or other data structure in each of the DRTs will have, in general, different local memory locations corresponding to a single memory name or identity, but each global “memory name” or identity will have the same “memory value or content” stored in the different local memory locations. So for each global name there will be a family of corresponding independent local memory locations with one family member in each of the computers. Although the local memory name may differ, the asset, object, location etc has essentially the same content or value. So the family is coherent.

The term “table” or “tabulation” as used herein is intended to embrace any list or organised data structure of whatever format and within which data can be stored and read out in an ordered fashion.

It will also be apparent to those skilled in the art in light of the description provided herein that the abovementioned modification of the application program code 50 during loading can be accomplished in many ways or by a variety of means. These ways or means include, but are not limited to at least the following five ways and variations or combinations of these five, including by:
(i) re-compilation at loading,
(ii) a pre-compilation procedure prior to loading,
(iii) compilation prior to loading,
(iv) “just-in-time” compilation(s), or
(v) re-compilation after loading (but, for example, before execution of the relevant or corresponding application code in a distributed environment).

Traditionally the term “compilation” implies a change in code or language, for example, from source to object code or one language to another. Clearly the use of the term “compilation” (and its grammatical equivalents) in the present specification is not so restricted and can also include or embrace modifications within the same code or language.

Those skilled in the computer and/or programming arts will be aware that when additional code or instructions is/are inserted into an existing code or instruction set to modify same, the existing code or instruction set may well require further modification (such as for example, by re-numbering of sequential instructions) so that offsets, branching, attributes, mark up and the like are properly handled or catered for.

Similarly, in the JAVA language memory locations include, for example, both fields and array types. The above description deals with fields and the changes required for array types are essentially the same mutatis mutandis. Also the present invention is equally applicable to similar programming languages (including procedural, declarative and object orientated languages) to JAVA including Microsoft.NET platform and architecture (Visual Basic, Visual C/C⁺⁺, and C#) FORTRAN, C/C⁺⁺, COBOL, BASIC etc.

The terms object and class used herein are derived from the JAVA environment and are intended to embrace similar terms derived from different environments such as dynamically linked libraries (DLL), or object code packages, or function unit or memory locations.

Various implementations are described relative to the above arrangements. Any one or each of these various arrangements may be implemented by computer program code statements or instructions (including by a plurality of computer program code statements or instructions) that execute within computer logic circuits, processors, ASICs, logic or electronic circuit hardware, microprocessors, microcontrollers or other logic to modify the operation of such logic or circuits to accomplish the recited operation or function. In another implementation firmware is used and in other implementations hardware. Furthermore, any one or each of these various implementations may be a combination of computer program software, firmware, and/or hardware.

Any and each of the abovedescribed methods, procedures, and/or routines may advantageously be implemented as a computer program and/or computer program product stored on any tangible media or existing in electronic, signal, or digital form. Such computer program or computer program products comprising instructions separately and/or organized as modules, programs, subroutines, or in any other way for execution in processing logic such as in a processor or microprocessor of a computer, computing machine, or information appliance; the computer program or computer program products modifying the operation of the computer in which it executes or on a computer coupled with, connected to, or otherwise in signal communications with the computer on which the computer program or computer program product is present or executing. Such a computer program or computer program product modifies the operation and architectural structure of the computer, computing machine, and/or information appliance to alter the technical operation of the computer and realize the technical effects described herein.

The invention may therefore constitute a computer program product comprising a set of program instructions stored in a storage medium or existing electronically in any form and operable to permit a plurality of computers to carry out any of the methods, procedures, routines, or the like as described herein including in any of the claims.

Furthermore, the invention includes (but is not limited to) a plurality of computers, or a single computer adapted to interact with a plurality of computers, interconnected via a communication network or other communications link or path and each operable to substantially simultaneously or concurrently execute the same or a different portion of an application code written to operate on only a single computer on a corresponding different one of computers. The computers are programmed to carry out any of the methods, procedures, or routines described in the specification or set forth in any of the claims, on being loaded with a computer program product or upon subsequent instruction. Similarly, the invention also includes within its scope a single computer arranged to co-operate with like, or substantially similar, computers to form a multiple computer system

The term “distributed runtime system”, “distributed runtime”, or “DRT” and such similar terms used herein are intended to capture or include within their scope any application support system (potentially of hardware, or firmware, or software, or combination and potentially comprising code, or data, or operations or combination) to facilitate, enable, and/or otherwise support the operation of an application program written for a single machine (e.g. written for a single logical shared-memory machine) to instead operate on a multiple computer system with independent local memories and operating in a replicated shared memory arrangement. Such DRT or other “application support software” may take many forms, including being either partially or completely implemented in hardware, firmware, software, or various combinations therein.

The methods of this invention described herein are preferably implemented in such an application support system, such as DRT described in International Patent Application No. PCT/AU2005/000580 published under WO 2005/103926 (and to which U.S. patent application Ser. No. 11/111,946 Attorney Code 5027F-US corresponds), however this is not a requirement of this invention. Alternatively, an implementation of the methods may take the form of a functional or effective application support system (such as a DRT described in the abovementioned PCT specification) either in isolation, or in combination with other softwares, hardwares, firmwares, or other methods of any of the above incorporated specifications, or combinations therein.

The reader is directed to the abovementioned PCT specification for a full description, explanation and examples of a distributed runtime system (DRT) generally, and more specifically a distributed runtime system for the modification of application program code suitable for operation on a multiple computer system with independent local memories functioning as a replicated shared memory arrangement, and the subsequent operation of such modified application program code on such multiple computer system with independent local memories operating as a replicated shared memory arrangement.

Also, the reader is directed to the abovementioned PCT specification for further explanation, examples, and description of various provided methods and means which may be used to modify application program code during loading or at other times.

Also, the reader is directed to the abovementioned PCT specification for further explanation, examples, and description of various provided methods and means which may be used to modify application program code suitable for operation on a multiple computer system with independent local memories and operating as a replicated shared memory arrangement.

Finally, the reader is directed to the abovementioned PCT specification for further explanation, examples, and description of various provided methods and means which may be used to operate replicated memories of a replicated shared memory arrangement, such as updating of replicated memories when one of such replicated memories is written-to or modified.

In alternative multicomputer arrangements, such as distributed shared memory arrangements and more general distributed computing arrangements, the above described methods may still be applicable, advantageous, and used. Specifically, any multi-computer arrangement where replica, “replica-like”, duplicate, mirror, cached or copied memory locations exist, such as any multiple computer arrangement where memory locations (singular or plural), objects, classes, libraries, packages etc are resident on a plurality of connected machines and preferably updated to remain consistent, then the methods may apply. For example, distributed computing arrangements of a plurality of machines (such as distributed shared memory arrangements) with cached memory locations resident on two or more machines and optionally updated to remain consistent comprise a functional “replicated memory system” with regard to such cached memory locations, and is to be included within the scope of the present invention. Thus, it is to be understood that the aforementioned methods apply to such alternative multiple computer arrangements. The above disclosed methods may be applied in such “functional replicated memory systems” (such as distributed shared memory systems with caches) mutatis mutandis.

It is also provided and envisaged that any of the described functions or operations described as being performed by an optional server machine X (or multiple optional server machines) may instead be performed by any one or more than one of the other participating machines of the plurality (such as machines M1, M2, M3 . . . Mn of FIG. 1).

Alternatively or in combination, it is also further provided and envisaged that any of the described functions or operations described as being performed by an optional server machine X (or multiple optional server machines) may instead be partially performed by (for example broken up amongst) any one or more of the other participating machines of the plurality, such that the plurality of machines taken together accomplish the described functions or operations described as being performed by an optional machine X. For example, the described functions or operations described as being performed by an optional server machine X may broken up amongst one or more of the participating machines of the plurality.

Further alternatively or in combination, it is also further provided and envisaged that any of the described functions or operations described as being performed by an optional server machine X (or multiple optional server machines) may instead be performed or accomplished by a combination of an optional server machine X (or multiple optional server machines) and any one or more of the other participating machines of the plurality (such as machines M1, M2, M3 . . . Mn), such that the plurality of machines and optional server machines taken together accomplish the described functions or operations described as being performed by an optional single machine X. For example, the described functions or operations described as being performed by an optional server machine X may broken up amongst one or more of an optional server machine X and one or more of the participating machines of the plurality.

The terms “object” and “class” used herein are derived from the JAVA environment and are intended to embrace similar terms derived from different environments, such as modules, components, packages, structs, libraries, and the like.

The use of the term “object” and “class” used herein is intended to embrace any association of one or more memory locations. Specifically for example, the term “object” and “class” is intended to include within its scope any association of plural memory locations, such as a related set of memory locations (such as, one or more memory locations comprising an array data structure, one or more memory locations comprising a struct, one or more memory locations comprising a related set of variables, or the like).

Reference to JAVA in the above description and drawings includes, together or independently, the JAVA language, the JAVA platform, the JAVA architecture, and the JAVA virtual machine. Additionally, the present invention is equally applicable mutatis mutandis to other non-JAVA computer languages (possibly including for example, but not limited to any one or more of, programming languages, source-code languages, intermediate-code languages, object-code languages, machine-code languages, assembly-code languages, or any other code languages), machines (possibly including for example, but not limited to any one or more of, virtual machines, abstract machines, real machines, and the like), computer architectures (possible including for example, but not limited to any one or more of, real computer/machine architectures, or virtual computer/machine architectures, or abstract computer/machine architectures, or microarchitectures, or instruction set architectures, or the like), or platforms (possible including for example, but not limited to any one or more of, computer/computing platforms, or operating systems, or programming languages, or runtime libraries, or the like).

Examples of such programming languages include procedural programming languages, or declarative programming languages, or object-oriented programming languages. Further examples of such programming languages include the Microsoft.NET language(s) (such as Visual BASIC, Visual BASIC.NET, Visual C/C++, Visual C/C++.NET, C#, C#.NET, etc), FORTRAN, C/C++, Objective C, COBOL, BASIC, Ruby, Python, etc.

Examples of such machines include the JAVA Virtual Machine, the Microsoft .NET CLR, virtual machine monitors, hypervisors, VMWare, Xen, and the like.

Examples of such computer architectures include, Intel Corporation's x86 computer architecture and instruction set architecture, Intel Corporation's NetBurst microarchitecture, Intel Corporation's Core microarchitecture, Sun Microsystems' SPARC computer architecture and instruction set architecture, Sun Microsystems' UltraSPARC III microarchitecture, IBM Corporation's POWER computer architecture and instruction set architecture, IBM Corporation's POWER4/POWER5/POWER6 microarchitecture, and the like.

Examples of such platforms include, Microsoft's Windows XP operating system and software platform, Microsoft's Windows Vista operating system and software platform, the Linux operating system and software platform, Sun Microsystems' Solaris operating system and software platform, IBM Corporation's AIX operating system and software platform, Sun Microsystems' JAVA platform, Microsoft's .NET platform, and the like.

When implemented in a non-JAVA language or application code environment, the generalized platform, and/or virtual machine and/or machine and/or runtime system is able to operate application code 50 in the language(s) (including for example, but not limited to any one or more of source-code languages, intermediate-code languages, object-code languages, machine-code languages, and any other code languages) of that platform, and/or virtual machine and/or machine and/or runtime system environment, and utilize the platform, and/or virtual machine and/or machine and/or runtime system and/or language architecture irrespective of the machine manufacturer and the internal details of the machine. It will also be appreciated in light of the description provided herein that platform and/or runtime system may include virtual machine and non-virtual machine software and/or firmware architectures, as well as hardware and direct hardware coded applications and implementations.

For a more general set of virtual machine or abstract machine environments, and for current and future computers and/or computing machines and/or information appliances or processing systems, and that may not utilize or require utilization of either classes and/or objects, the structure, method, and computer program and computer program product are still applicable. Examples of computers and/or computing machines that do not utilize either classes and/or objects include for example, the x86 computer architecture manufactured by Intel Corporation and others, the SPARC computer architecture manufactured by Sun Microsystems, Inc and others, the PowerPC computer architecture manufactured by International Business Machines Corporation and others, and the personal computer products made by Apple Computer, Inc., and others. For these types of computers, computing machines, information appliances, and the virtual machine or virtual computing environments implemented thereon that do not utilize the idea of classes or objects, may be generalized for example to include primitive data types (such as integer data types, floating point data types, long data types, double data types, string data types, character data types and Boolean data types), structured data types (such as arrays and records) derived types, or other code or data structures of procedural languages or other languages and environments such as functions, pointers, components, modules, structures, references and unions.

In the JAVA language memory locations include, for example, both fields and elements of array data structures. The above description deals with fields and the changes required for array data structures are essentially the same mutatis mutandis.

Any and all embodiments of the present invention are able to take numerous forms and implementations, including in software implementations, hardware implementations, silicon implementations, firmware implementation, or software/hardware/silicon/firmware combination implementations.

Various methods and/or means are described relative to embodiments of the present invention. In at least one embodiment of the invention, any one or each of these various means may be implemented by computer program code statements or instructions (possibly including by a plurality of computer program code statements or instructions) that execute within computer logic circuits, processors, ASICs, microprocessors, microcontrollers, or other logic to modify the operation of such logic or circuits to accomplish the recited operation or function. In another embodiment, any one or each of these various means may be implemented in firmware and in other embodiments such may be implemented in hardware. Furthermore, in at least one embodiment of the invention, any one or each of these various means may be implemented by a combination of computer program software, firmware, and/or hardware.

Any and each of the aforedescribed methods, procedures, and/or routines may advantageously be implemented as a computer program and/or computer program product stored on any tangible media or existing in electronic, signal, or digital form. Such computer program or computer program products comprising instructions separately and/or organized as modules, programs, subroutines, or in any other way for execution in processing logic such as in a processor or microprocessor of a computer, computing machine, or information appliance; the computer program or computer program products modifying the operation of the computer on which it executes or on a computer coupled with, connected to, or otherwise in signal communications with the computer on which the computer program or computer program product is present or executing. Such computer program or computer program product modifying the operation and architectural structure of the computer, computing machine, and/or information appliance to alter the technical operation of the computer and realize the technical effects described herein.

For ease of description, some or all of the indicated memory locations herein may be indicated or described to be replicated on each machine (as shown in FIG. 4A), and therefore, replica memory updates to any of the replicated memory locations by one machine, will be transmitted/sent to all other machines. Importantly, the methods and embodiments of this invention are not restricted to wholly replicated memory arrangements, but are applicable to and operable for partially replicated shared memory arrangements mutatis mutandis (e.g. where one or more memory locations are only replicated on a subset of a plurality of machines, such as shown in FIG. 4B).

To summarize, there is disclosed a multiple computer system having a first plurality of computers each interconnected via a communications network and a second like plurality of computers interconnected therewith, at least one memory location in each the second computer being a replica of a corresponding memory location in the corresponding first computer, and the system including updating means whereby changes to the contents or values of the memory locations in the first computers are transmitted to the corresponding memory locations of the second computers.

Preferably the first computers each have a local memory which is accessible by each other first computer wherein the first computers form a distributed shared memory system.

Preferably the second computers each have a local memory which is updateable by the corresponding first computer.

Preferably the updating means transmits changes in the first computer memory locations to the corresponding second computer memory location via the communications network.

Preferably the updating means transmits changes in the first computer memory locations so the corresponding second computer memory locations by transmission directly from each the first computer to the corresponding second computer.

Preferably the method includes failure means to re-direct communications to and from any one of the first computers which fails to the corresponding second computer.

Preferably the failure means causes the second computer corresponding to the failed first computer to undertake the tasks previously undertaken by the failed first computer.

Preferably each of the first computers executes a different portion of at least one application program each of which is written to execute on only a simple computer, each the second computer has a like application program portion as its corresponding first computer and all of the computers have an independent local memory, and at least one memory location in the independent memory of one of the first computers is replicated in each of the other first computers.

Preferably the updating means transmits changes in the first computer memory locations to the corresponding second computer memory location via the communications network.

Preferably the updating means transmits changes in the first computer memory locations to the corresponding second computer memory locations by transmission directly from each the first computer to the corresponding second computer.

Preferably the method includes failure means operable in the event of failure of any one or more of the first computers to cause the second computer corresponding to each the failed first computer to undertake the tasks previously undertaken by the failed first computer.

Also disclosed is a dual computer system comprising a first computer having an application program which is intolerant of computer failure, a second computer connected thereto to mirror the first computer, the second computer having a replica of the application program and having memory locations which replicate those of the first computer, and the computer system having updating means to update the second computer memory locations with changes to the contents or values of the corresponding memory locations of the first computer.

Preferably the system has a plurality of interconnected the first computers, each of which has a corresponding second computer connected thereto to mirror the corresponding first computer.

Preferably the plurality of first computers comprises a cluster.

Preferably the updating means transmits to each the second computer data relating to the progress of execution of instructions achieved by the corresponding first computer.

Preferably each of the first computers executes an application program, or a portion thereof, which is intolerant of failure of the executing first computer.

Also disclosed is a method of operating multiple computers to form a multiple computer system, the method comprising the steps of:

(i) interconnecting a first plurality of computers via a communications network,
(ii) interconnecting a like plurality of second computers to the first plurality of computers,
(iii) forming in each second computer a replica of at least one memory location of the corresponding first computer, and
(vi) updating the second computers whereby changes to the contents or values of the memory locations in the first computers are transmitted to the corresponding memory locations of the second computers.

Preferably the method includes the further step of:

(v) accessing the memory locations of each first computer from each other first computer to form a distributed shared memory system.

Preferably the method includes the further step of:

(vi) updating the memory location(s) of each the second computers by the corresponding first computer.

Preferably the method includes the further step of:

(vii) transmitting updating changes in the first computer memory locations to the corresponding second computer memory locations via the communications network.

Preferably the method includes the further step of:

(viii) transmitting updating changes in the first computer memory locations to the corresponding second computer memory locations directly from each first computer to the corresponding second computer.

Preferably the method includes the further step of:

(ix) in the event of failure of any one of the first computers re-directing communications to and from the failed first computer to the corresponding second computer.

Preferably the method includes the further step of:

(x) having the corresponding second computer undertake the tasks previously undertaken by the failed first computer.

Preferably the method includes the further steps of:

(xi) having each of the first computers execute a different portion of at least one application program each of which is written to execute on only a single computer,
(xii) providing each the second computer with a like application program portion as its corresponding first computer,
(xiii) providing all of the computers with an independent local memory, and
(xiv) replicating at least one local memory location in the independent memory of one of the first computer in each of the other first computers.

Preferably the method includes the further step of:

(xv) updating the memory location(s) of each the second computers by the corresponding first computer.

Preferably the method includes the further step of:

(xvi) transmitting updating changes in the first computer memory locations to the corresponding second computer memory locations via the communications network.

Preferably the method includes the further step of:

(xvii) transmitting updating changes in the first computer memory locations to the corresponding second computer memory locations directly from each first computer to the corresponding second computer.

Preferably the method includes the further step of:

(xviii) in the event of failure of any one of the first computers re-directing communications to and from the failed first computer to the corresponding second computer.

Preferably the method includes the further step of:

(ixx) having the corresponding second computer undertake the tasks previously undertaken by the failed first computer.

Also disclosed is a method of operating a dual computer system, the method comprising the steps of:

(i) providing a first computer,
(ii) loading into the first computer an application program which is written to operate on only a single (first) computer, and which is intolerant of failure of the first computer,
(iii) connecting a second computer to the first computer,
(iv) loading a replica of the application program in the second computer,
(v) replicating at least one memory location of the first computer in the second computer, and
(vi) updating changes in the content or value of the memory location(s) of the first computer to the corresponding memory location(s) of the second computer.

Preferably the method includes the further step of:

(vii) providing a plurality of interconnected the first computers, and
(viii) connecting a corresponding the second computer to each the first computer.

Preferably the method includes the step of:

(ix) operating the plurality of first computers as a cluster.

Preferably the method includes the further step of transmitting to each second computer data relating to the progress of the execution of instructions achieved by the corresponding first computer.

Preferably the method includes the step of executing in each of the first computers an application program, or a portion thereof, which is intolerant of failure of the executing first computer.

Still further there is disclosed a single computer adapted to operate in a multiple computer system as claimed in claim 1, the single computer comprising:

an independent local memory able to be updated via a communications port which is able to be connected to the communications network of the multiple computer system, and updating means connected to the communication port whereby changes to the contents or values of the memory locations of the single computer are able to be transmitted to the communications port of a like computer comprising a corresponding second computer of the multiple computer system.

In addition there is disclosed a multiple computer system comprising a first plurality of computers each of which is connected to each other by means of a communications network, a second like plurality of computers each of which is connected to each other by means of the communications network, and a substantially direct communications link between each of the first computers and the corresponding second computer.

Preferably at least some memory locations in each of the first computers, are replicated in the corresponding one of the second computers.

Preferably the method comprises a replicated memory system.

Preferably the method comprises a partial or hybrid replicated memory system.

Still further there is disclosed a multiple computer system having a first plurality of computers each interconnected via a communications network and a second like plurality of computers interconnected therewith, each of the first plurality of computers executing portions of a same application program written to operate on a single machine, and each of the first and second plurality computers comprising an independent local memory with at least one application memory location/content in each the second computer being a replica of a corresponding application memory location in the corresponding first computer, and the system including updating means whereby changes to the contents or values of the application memory locations/contents in the first computers are transmitted to the corresponding application memory locations of the second computers.

Also there is disclosed a dual computer system, each the dual computers comprising an independent local memory, the dual computer system comprising a first computer having an application program which is written to operate on a single computer and is intolerant of computer failure, a second computer connected thereto to mirror the first computer, the second computer having a replica of the application program and having at least one application memory locations/contents which replicate those of the first computer, and the computer system having updating means to update the second computer application memory locations/contents with changes to the contents or values of the corresponding application memory locations/contents of the first computer.

In addition there is disclosed a single computer adapted to operate in a multiple computer system or a dual computer system as above, the single computer comprising:

an independent local memory in which at least one application memory location/content is replicated in each independent local memory of each the computers and able to be updated via a communications port which is able to be connected to the communications network of the multiple computer system, and updating means connected to the communication port whereby changes to the contents or values of the application memory locations/contents of the single computer are able to be transmitted to the communications port of a like computer comprising a corresponding second computer of the multiple computer system, and where the single computer is operating a portion of an application program written to operate on only a single computer and intolerant of failure of a single computer.

Furthermore there is disclosed a method of operating multiple computers to form a multiple computer system, each single computer of the multiple computers comprising an independent local memory, and each the single computer executing a portion of an application program written to operate on only a single computer and intolerant of failure, and with at least one application program memory location/content replicated in the independent local memories of each of the single computers, the method comprising the steps of:

(i) interconnecting a first plurality of computers via a communications network,
(ii) interconnecting a like plurality of second computers to the first plurality of computers,
(iii) forming in each second computer a replica of at least one application memory location/content of the corresponding first computer, and
updating the second computers whereby changes to the contents or values of the application memory locations/contents in the first computers are transmitted to the corresponding application memory locations/contents of the second computers.

Further still there is disclosed a method of operating a dual computer system, each single computer of the dual computers comprising an independent local memory, and where a first one of the dual computers executing a portion of an application program written to operate on only a single computer and intolerant of failure, and with at least one application program memory location/content replicated in the independent local memories of each of the single computers, the method comprising the steps of:

(i) providing a first computer,
(ii) loading into the first computer an application program which is intolerant of failure of the first computer,
(iii) connecting a second computer to the first computer,
(iv) loading a replica of the application program in the second computer,
(v) replicating at least one application memory locations/contents of the first computer in the second computer, and
(vi) updating changes in the content or value of the application memory locations/contents of the first computer to the corresponding application memory locations/contents of the second computer.

Also disclosed is a multiple computer system comprising a first plurality of computers each of which is connected to each other by means of a communications network, a second like plurality of computers each of which is connected to each other by means of the communications network, and a substantially direct communications link between each of the first computers and the corresponding second computer, each of the computers comprising an independent local memory, and each single computer of the first plurality executing a portion of an application program written to operate on only a single computer and intolerant of computer failure, with at least one application program memory location/content replicated in each of the first plurality and second plurality computers.

The term “comprising” (and its grammatical variations) as used herein is used in the inclusive sense of “having” or “including” and not in the exclusive sense of “consisting only of”.

I/we claim:

1. A single computer adapted to operate in a multiple computer system that includes a first plurality of computers each interconnected via a communications network and a second like plurality of computers interconnected therewith, at least one memory location in each said second computer being a replica of a corresponding memory location in the corresponding first computer, and first updating means for transmitting changes to the contents or values of said memory locations in said first computers to the corresponding memory locations of said second computers; said single computer comprising:
an independent local memory able to be updated via a communications port which is able to be connected to the communications network of said multiple computer system; and
second updating means connected to said communication port so that changes to the contents or values of said memory locations of said single computer are able to be transmitted to the communications port of a like computer comprising a corresponding second computer of the multiple computer system.

2. In a single computer adapted to operate in a multiple computer system that includes a first plurality of computers each interconnected via a communications network and a second like plurality of computers interconnected therewith, at least one memory location in each said second computer being a replica of a corresponding memory location in the corresponding first computer, a method comprising:
identifying changes or updates to the contents or values of said memory locations in said first computers;
transmitting said changes or updates in said first computers to the corresponding memory locations of said second computers; and
updating an independent local memory via a communications port which is able to be connected to the communications network of said multiple computer system; and
transmitting changes to the contents or values of said memory locations of said single computer to a another one of said plurality of computers.

3. A multiple computer system comprising:
a first plurality of computers each of which is connected to each other by means of a communications network;
a second like plurality of computers each of which is connected to each other by means of said communications network; and
a substantially direct communications link between each of said first computers and the corresponding second computer.

4. The multiple computer system as in claim 8, wherein at least some memory locations in each of said first computers, are replicated in the corresponding one of said second computers.

5. The multiple computer system as in claim 3, and comprising a replicated memory system.

6. The multiple computer system as in claim 3, and comprising a partial or hybrid replicated memory system.
